(19) United States
(12) Patent Application Publication
(10) Pub. No.: US 2012/0084210 A1
(43) Pub. Date: Apr. 5, 2012

(54) MOBILE DEVICE PAYMENT SYSTEM

(76) Inventor: Arvin Farahmand, San Francisco, CA (US)

(21) Appl. No.: 12/894,701

(22) Filed: Sep. 30, 2010

(51) Int. Cl. G06Q 40/00; G06Q 20/00

(52) U.S. Cl. 705/64; 705/44; 705/39

(57) ABSTRACT

Technology is provided for using a mobile device as part of a payment system. The mobile device utilizes an accessory with a security feature based on its connection state to the mobile device. When the accessory detects disconnection, the accessory deletes user account information on the accessory. When in a valid connection state, the accessory transmits a user payment service account identification and an accessory identification to a transceiver of a merchant computer system to initiate a transaction. A payment service system eventually receives the information transmitted by the accessory, and contacts the mobile device associated with the account for transaction approval in one example. Thus, the user initiates the transaction at his/her mobile device using the connected mobile device accessory, and approves the transaction on his/her mobile device. In other examples, the user can send approval in a transmission to the merchant system or set up other pre-authorization criteria.

### BACKGROUND

The ubiquity of mobile devices provides users with connectivity to other computer systems from many locations. These mobile devices are making up a key part of a computing infrastructure. As other communication systems are developing applications to leverage this mobile infrastructure, payment systems have also. In some payment systems, the user swipes the mobile device (e.g., with an external Radio Frequency Identification [RFID] tag), and receives a confirmation, but the confirmation comes after a transaction has been completed. Thus, an unauthorized transaction can be completed despite the notice to help uncover it later. In other instances, the payment is completed at a reader terminal or computer system of a point-of-sale location requiring the user to enter a personal identification code (PIN) into a third party computer system. A misappropriated PIN can cause unauthorized charges. The loss of the mobile device RFID tag can allow another person to make unauthorized purchases. Security enhancements which limit the opportunities for loss of information used to access a user's money and to make unauthorized charges can further encourage growth of a mobile device payment system infrastructure.

### SUMMARY

Technology is provided for a mobile device system suitable for use in a secure and flexible mobile device payment system. In some embodiments for systems or apparati, the system or apparatus includes a mobile device payment accessory. In some embodiments, the mobile device payment accessory is communicatively coupled with a mobile device in a system or an apparatus. One example of a mobile device is a cellular telephone, including a smart phone. Other types of mobile devices can also be used including, but not limited to, a tablet, notebook computer, music player, or other mobile computing device.

In one embodiment, the mobile device payment accessory includes a processor and a memory system accessible by the processor. The processor has a mobile device communication interface for receiving data from a mobile device. The accessory processor stores the data in the memory system of the accessory. In one embodiment, the mobile device accessory is internal to the mobile device or implemented using the hardware and software components of the mobile device. In some embodiments, the mobile device payment accessory is a removable external accessory, and the mobile device communication interface is an external input communication interface. In one example, the external input interface includes a physical connection to an earphone jack of the mobile device through which the accessory receives an analog signal encoded with data.

In some embodiments, a connection detection circuit of the accessory is communicatively coupled to the processor for indicating the connection state of the accessory with respect to the mobile device. The memory system includes software executable by the processor for erasing the data received from the mobile device responsive to an indicator from the connection detection circuit that the accessory has been disconnected from the mobile device.

Technology is provided for a method of making a payment using a mobile device system. A transaction data set including a user account identification for a payment service account is transmitted by the system to a transceiver connected to a merchant computer network system in communication, for example via an Internet connection, with a computer network system of a payment service. In some embodiments, the mobile device system includes a mobile device and a removable external accessory or apparatus which can be connected to the mobile device.

In some embodiments, a mobile device associated with the user account identification receives a message requesting approval of the transaction from the remote payment service computer network via a communication network accessible by the mobile device. The mobile device sends a response message including a purchase decision for the transaction to the payment service computer network via the communication network. Thus, the transaction begins with the mobile device and is approved at the mobile device. In other embodiments, an approval indicator can be sent with the account identification or pre-authorization criteria can be established.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments of the technology for a mobile device system and its use in a payment system in accordance with this specification are further described with reference to the accompanying drawings.

FIG. 1 illustrates an embodiment of a mobile device system including a mobile device payment accessory connected via an earphone jack to a mobile device.

FIG. 2A illustrates an embodiment of a system architecture of a mobile device payment accessory.

FIG. 2B illustrates another embodiment of a system architecture of a mobile device payment accessory in which the accessory is coupled to an earphone jack of the mobile device.

FIG. 2C illustrates another embodiment of a system architecture of a mobile device payment accessory in which analog to digital conversion is performed by a digital audio encoder.

FIG. 3A illustrates an embodiment of a method for deactivating the accessory upon disconnection from the mobile device.

FIG. 3B illustrates an embodiment of a capacitance sensor as a connection detection circuit.

FIG. 3C illustrates an embodiment of a magnetic sensor as a connection detection circuit.

FIG. 4 illustrates an embodiment of a system architecture for a payment system in which the mobile device system can be used.

FIG. 5A illustrates an example embodiment of a reader computer system including computer hardware and software components.

FIG. 5B illustrates an example embodiment of a mobile device computer system including computer hardware and software components.

FIG. 5C illustrates another example embodiment of a mobile device computer system comprising an internal RFID transceiver and other computer hardware and software components.

FIG. 5D illustrates an example embodiment of a merchant computer system including computer hardware and software components.

FIG. 5E illustrates an example embodiment of a payment service computer system including computer hardware and software components.

FIG. 5F illustrates an example embodiment of software components which may be included in a mobile device software application.

FIG. 5G illustrates an example embodiment of software components which may be included in payment service software.

FIG. 6A is a flowchart illustrating one embodiment of a method for setting up user access to a mobile device payment system.

FIG. 6B is a flowchart illustrating a method embodiment for setting up an account with a payment service website.

FIG. 6C is a flowchart illustrating a method embodiment for linking third party services with a user payment service account.

FIG. 6D is a flowchart illustrating a method embodiment for setting up a mobile device payment service application on a mobile device.

FIG. 6E is a flowchart illustrating a method embodiment for initializing the mobile device payment accessory.

FIG. 7A is flowchart illustrating a method embodiment for making a payment using a mobile device payment system.

FIG. 7B is flowchart illustrating a method embodiment for making a payment using the mobile device payment accessory from the perspective of the accessory.

FIG. 7C is flowchart illustrating a method embodiment for making a payment using the mobile device payment accessory from the perspective of the merchant computer network system.

FIG. 7D is flowchart illustrating a method embodiment for making a payment using the mobile device payment accessory from the perspective of the payment service computer network system.

FIG. 7E is flowchart illustrating a method embodiment for making a payment using the mobile device payment accessory from the perspective of the mobile device.

FIG. 7F illustrates various examples of various data sets sent between the computer systems to complete a purchase transaction.

FIG. 8A is a flowchart of one embodiment of a method for displaying a purchase approval request as part of a partial bill payment feature in a mobile device payment system.

FIG. 8B is an example of a display which can be generated by a method embodiment for paying part of a bill using a mobile device payment accessory.

FIG. 8C is an example of an updated display showing the user's modifications to the bill to cover the portion of charges he incurred which can be generated by the method embodiment discussed with respect to FIG. 8B.

FIG. 9 is an embodiment of a method for automated formatting of user feedback on a purchase transaction.

### DETAILED DESCRIPTION

The figures illustrate various embodiments of technology for a mobile device, a mobile device payment accessory and their use in a payment system. The mobile device payment accessory described below is not tied to a particular type or brand of mobile device. No custom port or adapter is needed to connect the accessory to the mobile device. A software application for the payment system can be developed based on the various mobile device platforms such as the Symbian® operating system for Nokia, the iOS® operating system for Apple, the Android® operating system from Google, and the Blackberry® operating system of Research In Motion to name a few.

As will be discussed below, the disconnection of the accessory from the mobile device includes a security feature to prevent unauthorized use of the accessory if it becomes separated from the mobile device. Another security feature in some embodiments in the payment system or payment method for a transaction is that a transaction process may begin with the accessory connected to the mobile device and must be approved by the user at the mobile device of the user from whose account the purchase amount is to be deducted.

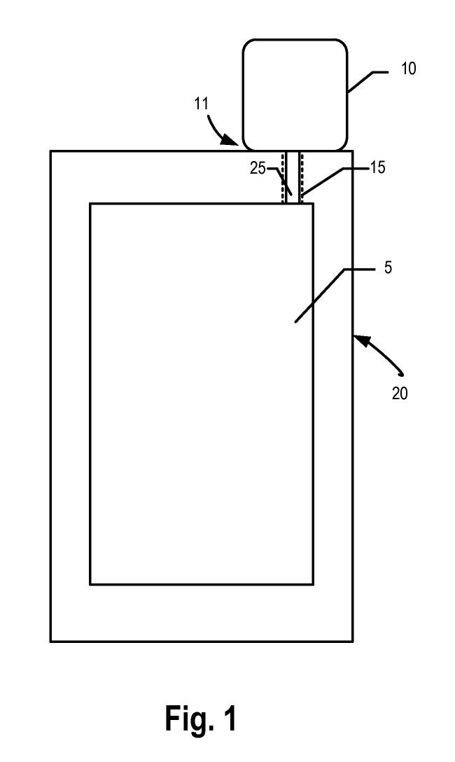

FIG. 1 illustrates an embodiment of a mobile device system which can be used with a mobile device payment system. A mobile device payment accessory 10 is a removal external accessory in this embodiment. In this example, an earphone connector 25, which is part of an external input communication interface, extends out of a wall 11 of accessory 10 and connects via an earphone jack 15 to a mobile device 20. In this example, the mobile device 20 is a smart phone.

Using a software application downloaded onto the mobile device, the user, using a touchscreen 5 in this example, loads accessory 10 with data to be used during transactions during an initialization procedure. The amount of data transferred between the accessory 10 and the mobile device 20 is relatively small. Examples of such data are an encryption value which can be an encryption key or an encryption seed for a pseudo random number generator, a user account identification for a payment service, and an accessory identification which uniquely identifies this particular accessory device 10. Other types of user profile data can also be stored or programmed into the accessory by the mobile device. The accessory may use some of the data items such as an encryption seed or key for calculations resulting in data items such as encrypted values which may be part of a transmission for a transaction. The accessory stores the data for later usage for calculation or transmission during transactions.

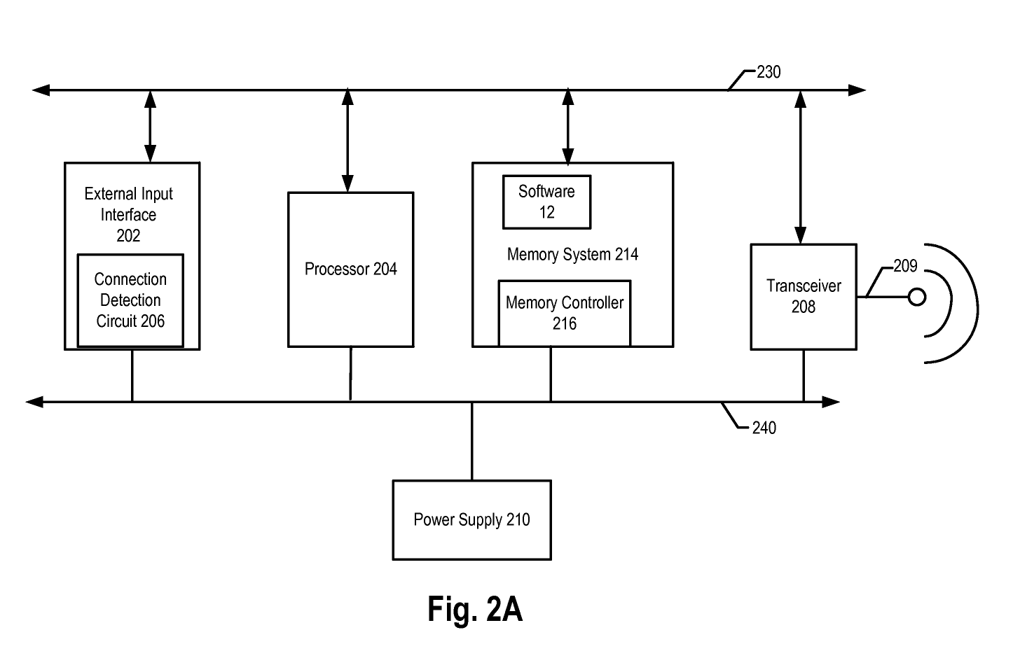

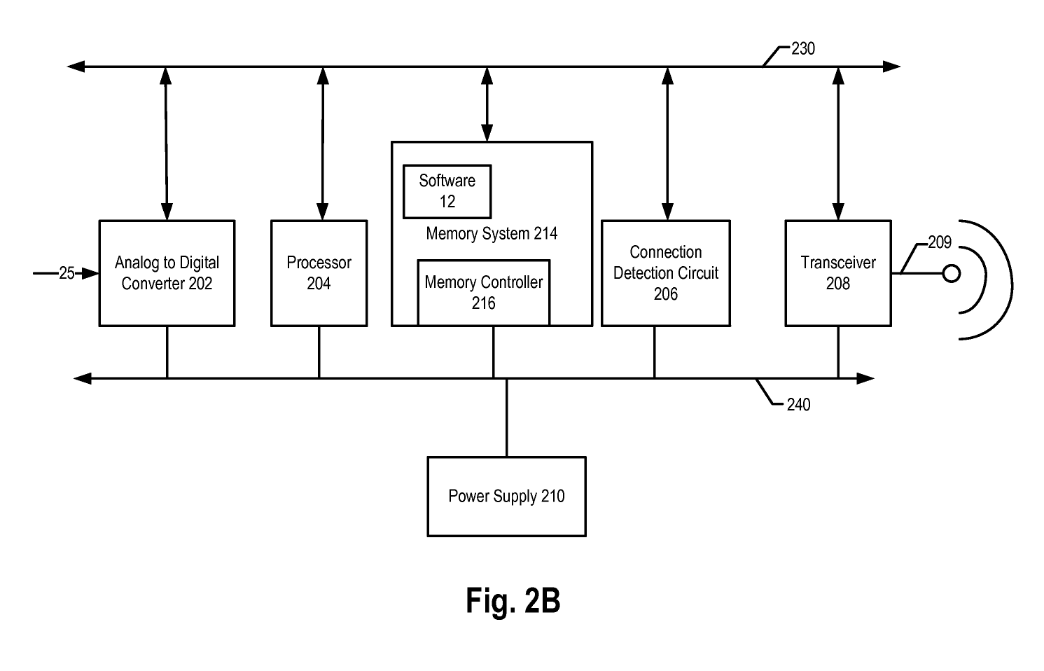

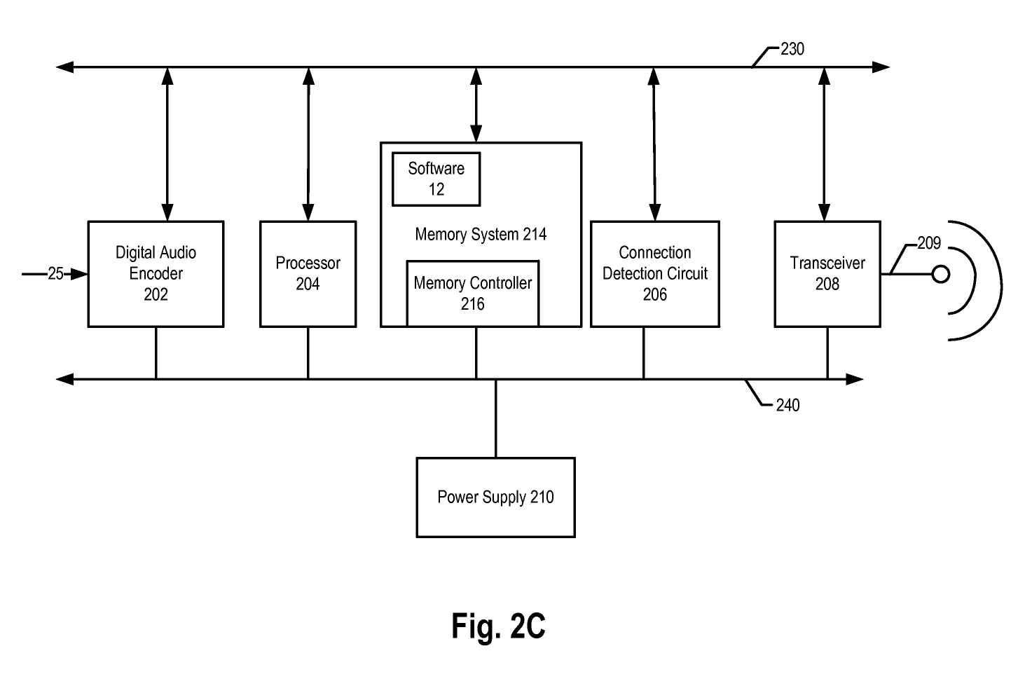

FIG. 2A illustrates one embodiment of a system architecture of a mobile device payment accessory 10. In this embodiment, an external input communication interface 202 communicatively couples with the mobile device 20. Communication can be via a wired or a wireless connection. The interface 202 processes the data signal from the mobile device 20 to send a usable digital signal over communication bus 230 to a processor 204 of the accessory.

In this embodiment, the interface 202 includes a connection detection circuit 206 for automatically detecting when the accessory 10 is connected to the mobile device 20 and when it has been disconnected. Responsive to receiving output indicating disconnection, the connection detection circuit 206 sends an indicator to the processor 204 via communication bus 230. A security feature of the accessory is that when it is disconnected from the mobile device 20, the accessory will automatically erase all user profile data from memory system 214 in order to prevent unauthorized purchases.

In one embodiment, the mobile device communication interface shown here as an external input interface 202 can use a standard wireless communication interface, some examples of which are a Near Field Communication (NFC), a radio frequency protocol or a Bluetooth connection for connecting over a short distance to the mobile device 20. Any known Bluetooth pairing technique can be used. For example, the two devices can create and store a link key which lets them authenticate the identity of the other device. The data transmitted between the devices can then be encrypted to prevent electronic eavesdropping. A user can initiate pairing by entering a personal identification number or password on the mobile device 20 to activate the Bluetooth pairing. In another example, Secure Simple Pairing (SSP) can be used. Other wireless protocols besides Bluetooth can also be used. The connection state of the accessory 10 can be determined in the manner that a standard Bluetooth interface identifies disconnection and connection.

In another embodiment, the external input interface 202 can include a standard peripheral device interface such as a Universal Serial Bus (USB) interface and, again, the connection state of the accessory 10 can be determined as the standard peripheral device interface normally determines disconnection.

During initialization, the mobile device 20 sends user profile data, at least some of which is used during transactions by accessory 10, to the processor 204 over the external input interface 202 which user profile data the processor 204 then sends over communication bus 230 to a memory controller 216 of a memory system 214 for storage. In one embodiment, the processor 204 is a microcontroller. The memory system 214 can include both volatile and non-volatile storage. For example, software 12 for the processor 204 to execute can be stored in non-volatile memory such as read only memory (ROM), or flash memory. The data for transactions can be stored in non-volatile memory like flash memory if desired, or in volatile memory such as random access memory (RAM) in any of its various forms (e.g. Static RAM (SRAM) or Dynamic RAM (DRAM)).

The transceiver unit 208 includes analog to digital and digital to analog converters so that it can transmit data at a particular frequency and process data in a digital form usable by the processor 204 and the memory system 214. As the accessory comes into the vicinity of a reader transceiver connected with a merchant computer system, the wireless transceiver 208 can detect a signal and inform the processor 204 via communication bus 230 of the detection. The processor 204 under the control of software 12 can cause the transceiver 208 to include the transaction data in a transmission over its antenna 209 to the reader transceiver. In one embodiment, the reader transceiver includes a Radio Frequency Identification (RFID) sensor, and the transceiver 208 transmits transaction data as part of an RFID tag.

Other technologies can also be used between a reader and the accessory. For example, the reader and accessory can communicate using Near Field Communication (NFC) which provides two way communication and operates within four (4) inches. In other examples, the user can touch the transceiver 208 of the accessory 10 to the reader to cause the transfer of data.

In other embodiments, one or more of the modules 202, 216, 208, 206 can communicate with the processor 204 directly through a port rather than using a communication bus 230.

The accessory 10 includes a power supply 210, for example a battery or a solar powered battery which supplies power via power bus 240 to the external input communication interface 202, the processor 204, the memory system 214, the transceiver 208, and the connection detection circuit 206.

FIG. 2B illustrates another embodiment of a system architecture of a mobile device payment accessory in which the accessory includes a communication connector or coupling 25 as part of the external input interface 202 that is physically connected to an earphone jack of the mobile device. For example, this embodiment could be used in a system like that shown in FIG. 1. In some examples, the physical connection can be a wireless connection, such as that used with wireless earphones. The external input communication interface 202 includes an analog to digital converter for receiving the analog signal from the earphone jack connection 15 over connector 25. The transaction data is encoded on the analog signal by the mobile device 20 and the analog to digital converter 202 employs a conversion scheme to decode the data for representation in a digital form usable by the processor 204. For example, the analog signal can be created, modulated and demodulated using similar technology as used in modems (modulator demodulator) for Plain Old Telephone System (POTS) lines. In one example, sound creation software (e.g. that used for MIDI® keyboards and Java™ Sound) can be used as an audio signal encoder (e.g. 503) to generate two tones representing respectively bit values of one and zero which triggers the A/D converter 202 to take on the value of zero or one depending on the tone. Other tone schemes can be used with more than two tones representing different data, for example 16 tones to represent 4 bits at a time.

In this embodiment, connection detection circuit 206 is separate from the analog to digital converter 202 acting within the external input communication interface 202.

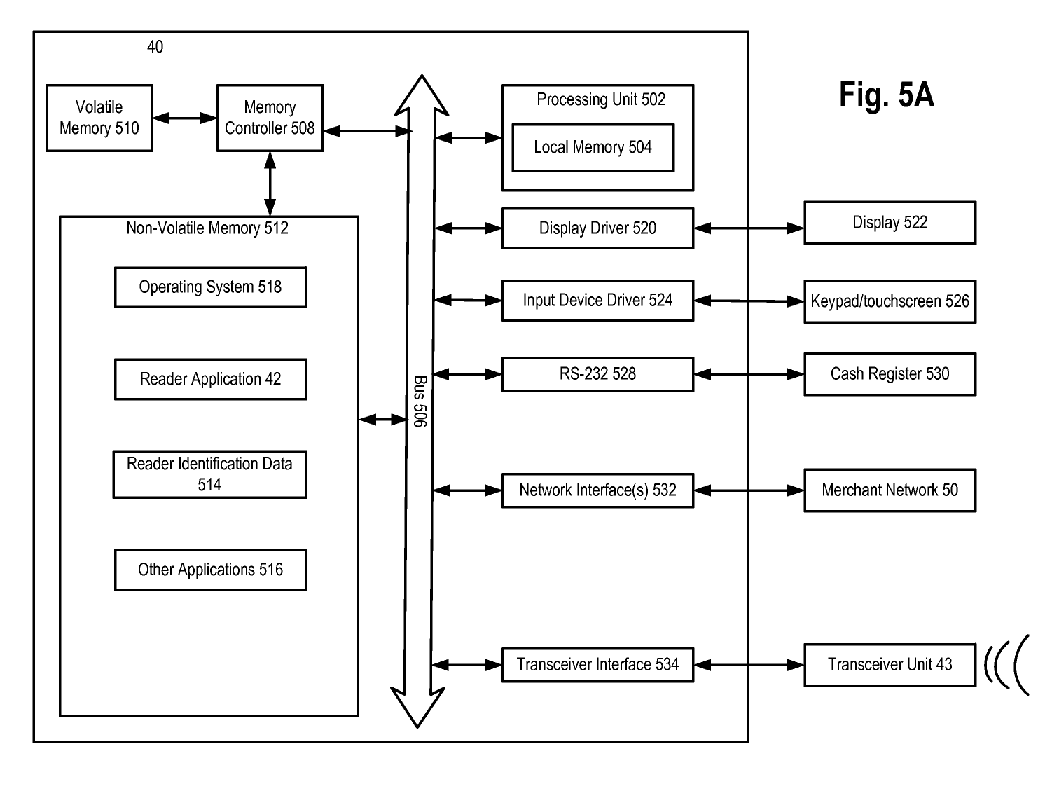

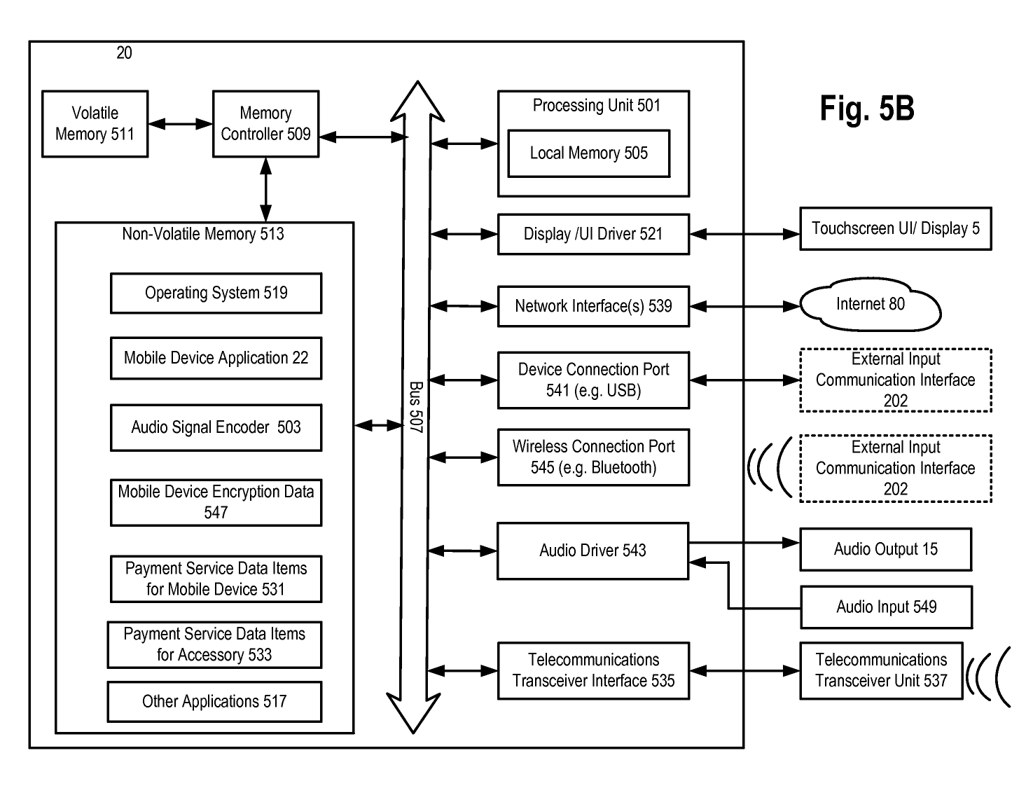

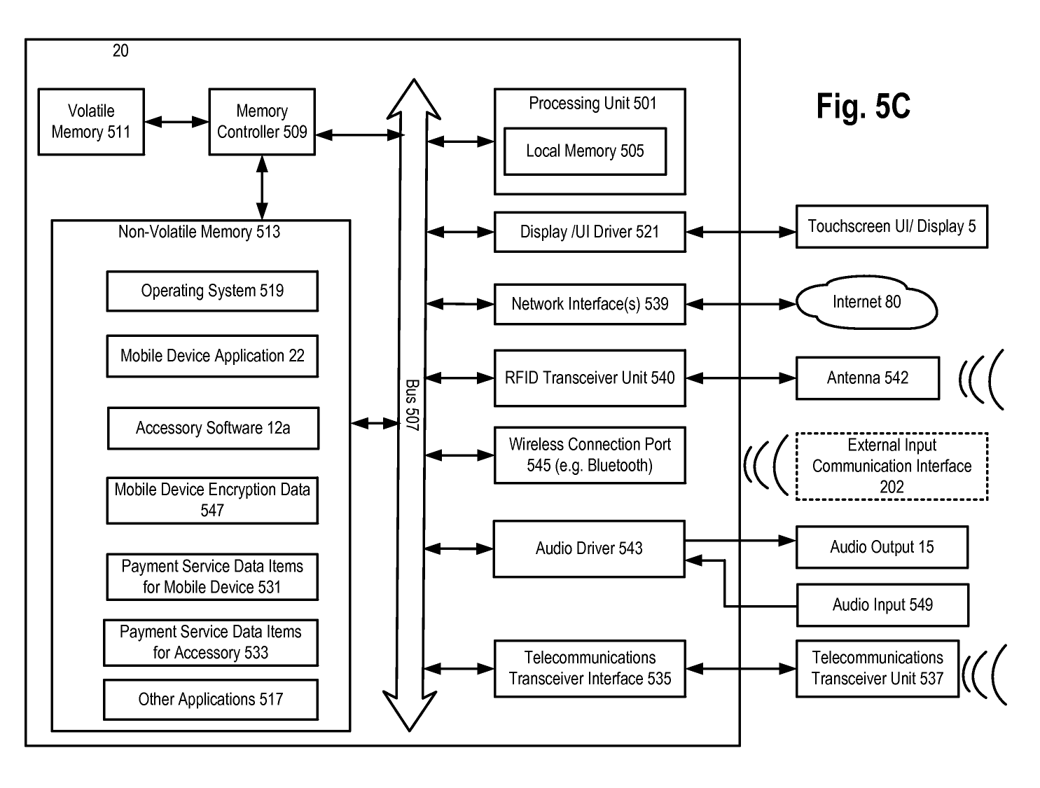

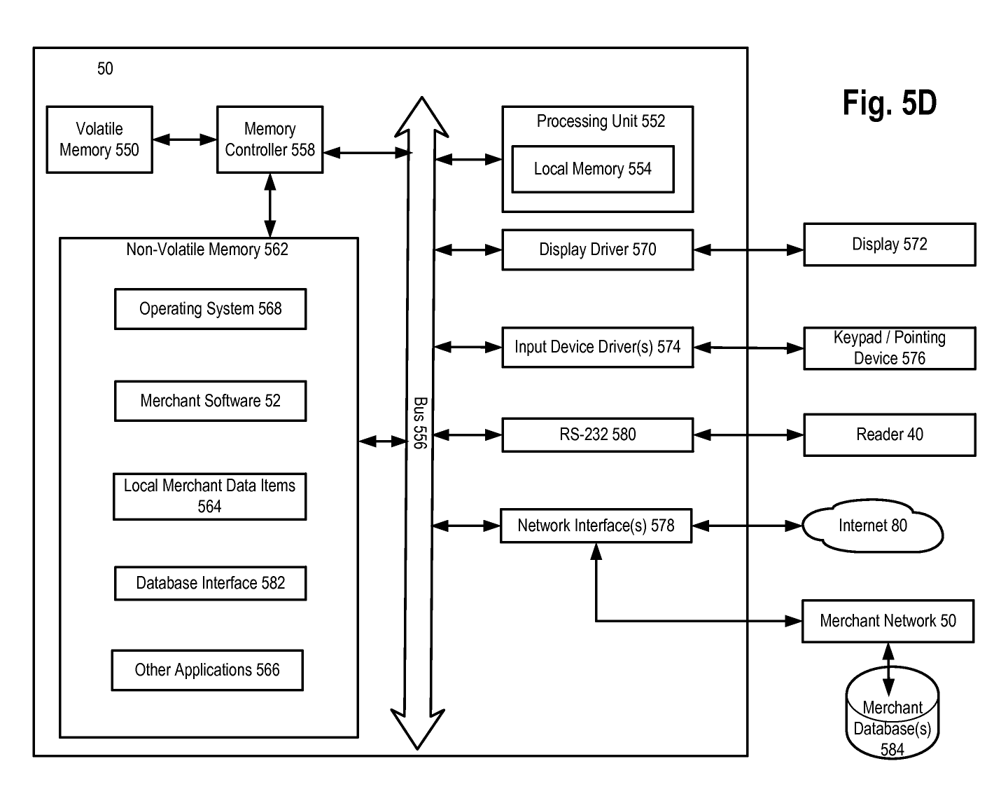

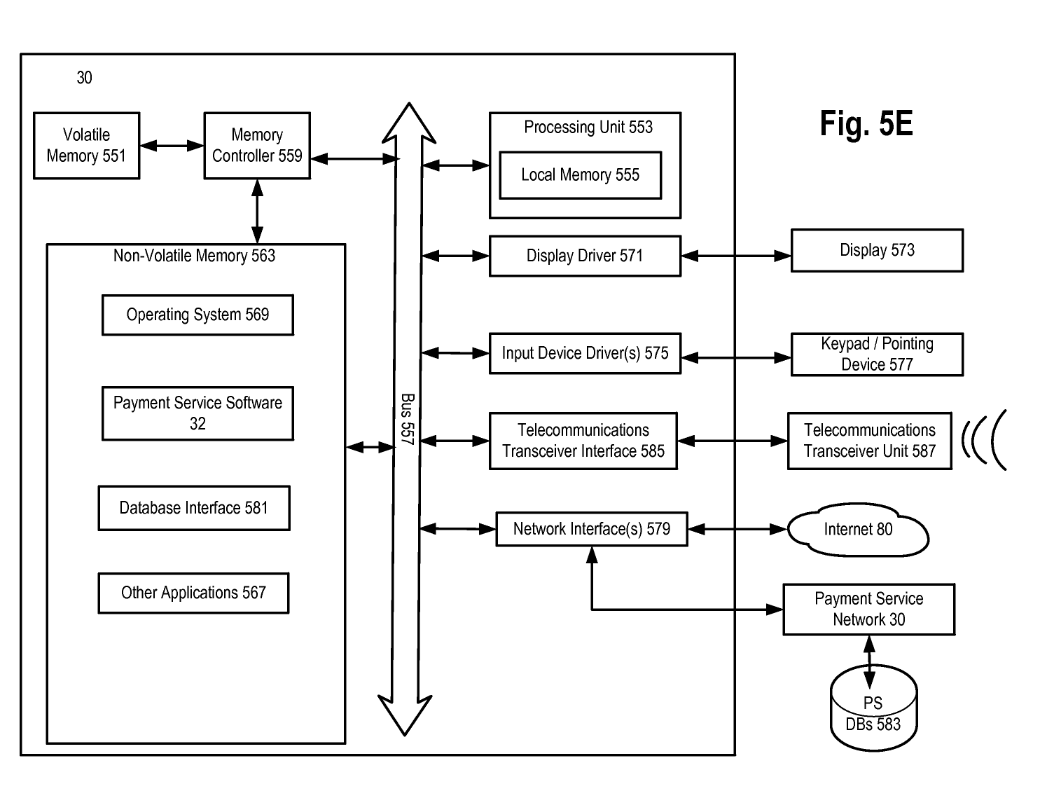

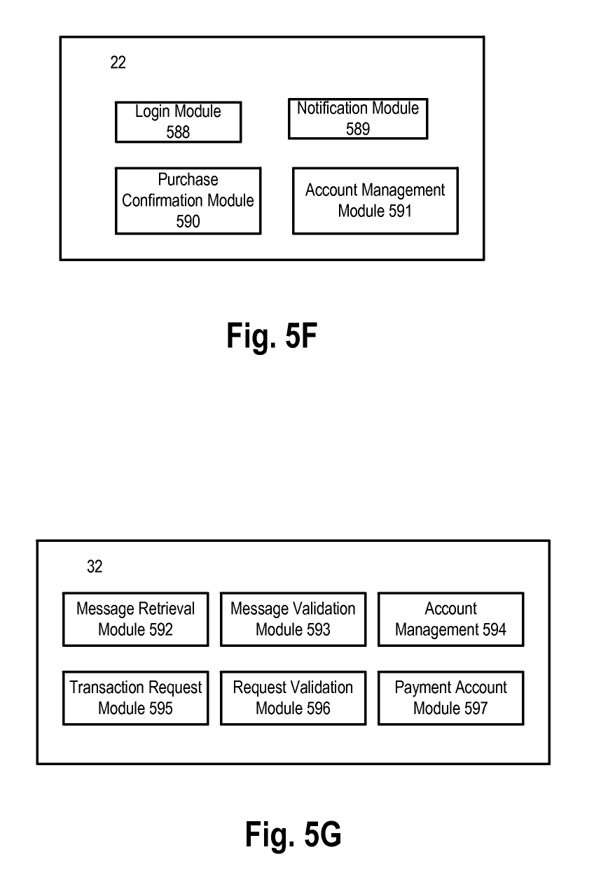

FIG. 2C illustrates another embodiment of a system architecture of a mobile device payment accessory in which analog to digital conversion is performed by a digital audio encoder. As many mobile devices support different audio compression formats to represent sound files to be played by a resident player through the earphone jack, a software application on the mobile device 20 can save the user profile data including the transaction data to be transferred to the accessory 10 during the initialization procedure as a file already digitally sampled. Examples of audio compression formats include formats such as MP3, WAV and FLAC. An uncompressed pulse code modulated signal stored in a WAV container can also be stored as a digital audio file. For a lossy compression algorithm like MP3, using a same resolution level can be used to match the data file originally saved on the mobile device. FLAC is an open source digital audio format, and it is also lossless. The mobile device 20 has an audio driver (see 543 in FIG. 5B) to generate a sound file based on the digital audio file data (e.g user profile data including transaction data) to be transferred, and this is played through the earphone jack. The digital audio encoder 202 of FIG. 2C then encodes the audio signal into a digital file using one of the audio compression schemes. If pulse code modulation is used, then pulse code demodulation can be used by the encoder 202 to create a digital representation of the transferred data. The encoder then forwards the digital version of the transaction data to the processor 204 via the communication bus 230.

As will be described below, during initialization the mobile device programs or stores user profile data into the accessory 10 via the earphone jack or other means. That user profile data will be used by accessory 10 to generate each transaction. One security feature provided by the accessory 10 described herein is that if the accessory 10 is removed from the mobile device 20, then the accessory 10 automatically erases all user profile data so that accessory 10 is made non-functional.

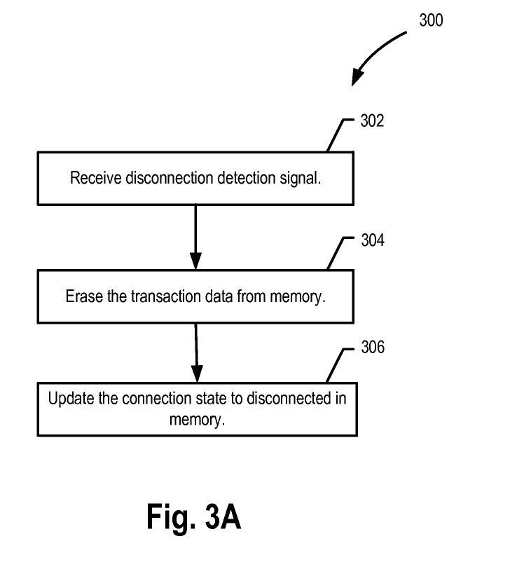

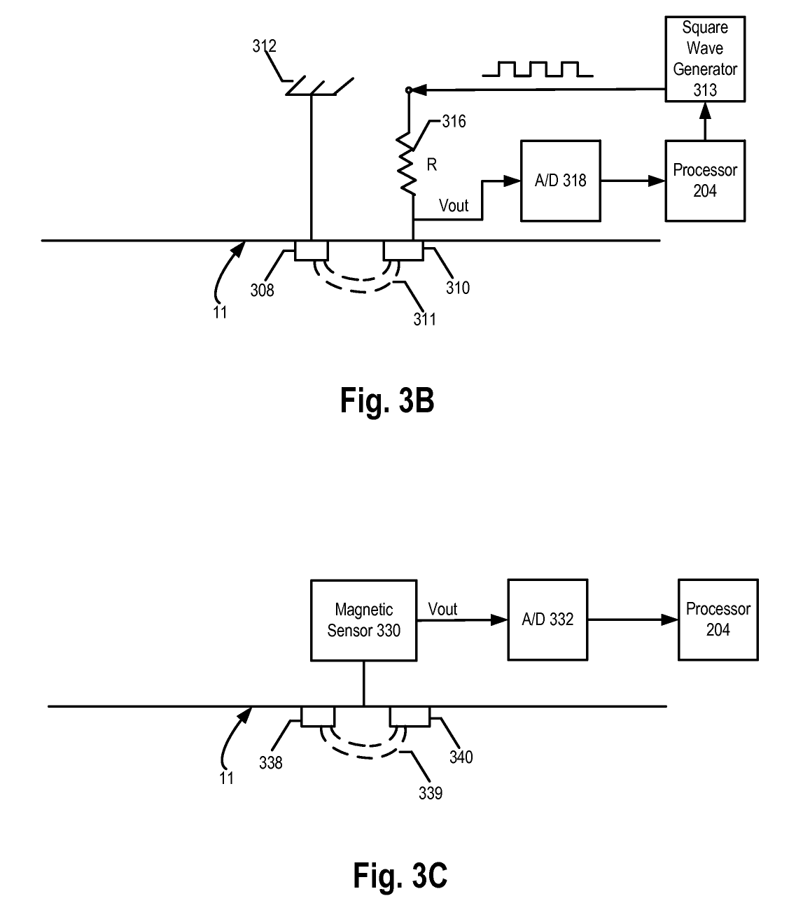

FIG. 3A illustrates an embodiment of a method for making the accessory non-functional upon disconnection/removal from the mobile device. FIG. 3A is discussed in terms of the embodiments of FIGS. 2A to 2C for illustrative purposes only and not to be limiting thereof. In step 302, the processor 204 receives a disconnection detection signal from the connection detection circuit 206. It can be received via the bus 230 or the connection detection circuit 206 can be directly connected to a port of the processor in another embodiment. Responsive to receiving the disconnection signal, in step 304 the accessory software 12 executing on the processor 204 erases all user profile data from the memory 214 of the accessory. The software 12 updates in step 306 a connection state in memory to disconnected. The software 12 may also put the accessory in an inactive mode such as a sleep mode to save power. As discussed below, only performing the initialization procedure for the accessory causes the state to be changed from disconnected. Merely connecting the accessory 10 to a mobile device 20 will not update the state. The data erased in step 304 can include all data programmed into the accessory 10 by mobile device 20.

FIG. 3B illustrates an example capacitance sensor circuit, which is one embodiment of a circuit which automatically detects connection and disconnection. The connection detection circuit is discussed in terms of the configuration of FIG. 1 for FIGS. 3B and 3C for illustrative purposes only and not to be limiting thereof. In this embodiment, on the wall 11 of the accessory 10, two conductors 308 and 310 with a gap in between form a capacitor 311 with electric field lines extending outside the wall 11 of the accessory 10. Conductor 308 is connected to ground 312, and conductor 310 is connected to a voltage source 313 across a resistor 316. The capacitor 311 forms a RC circuit with the resistor 316. The RC circuit is charged and discharged via a switchable voltage source 313, in this example, under the control of software 12 executing on the processor 204. Any object placed immediately next to the wall 11 of the accessory 10 will cross the electric fields of capacitor 311 and change its effective capacitance directly affecting the charge or discharge time of the RC circuit. Analog to digital converter 318 can measure the voltage Vout and send it to the processor 204 via communication bus 230 to determine the charge or discharge time. When a change limit in the charge or discharge time is crossed, disconnection from the mobile device is determined by processor 204.

FIG. 3C illustrates an example magnetic sensor circuit, which is another embodiment of a connection detection circuit. In this embodiment, a magnetic field 339 strength between attractive magnets 338 and 340, e.g. a north pole and a south pole is measured by a magnetic sensor 330 such as a Hall effect sensor. The sensor 330 outputs a voltage to an analog to digital converter 332 to represent the output in digital form to the processor 204 for software 12 to evaluate changes in the magnetic field strength based on the values received. In one example, disruption of the magnetic field indicates connection, and an increase in field strength above a threshold can indicate disconnection. In other embodiments, a decrease in field strength can indicate disconnection.

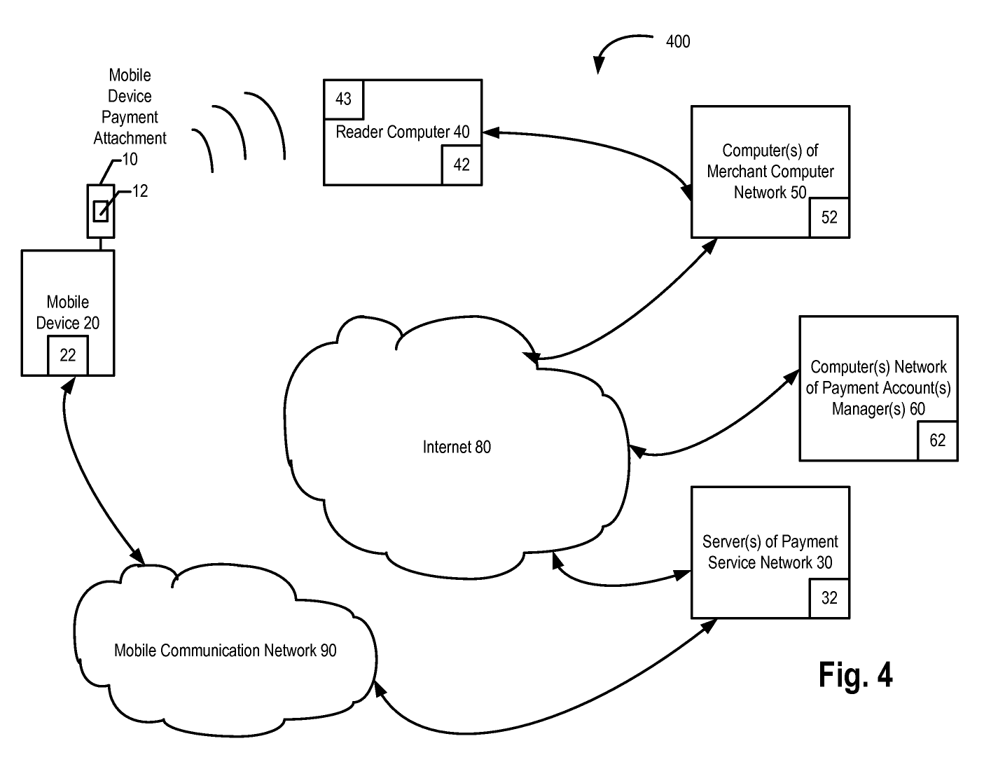

FIG. 4 illustrates one embodiment of a system architecture for a payment system 400 in which the mobile device payment system can be used. In the illustrated embodiment, the mobile device payment accessory 10 is a removable accessory external to the mobile device 20. Other embodiments of a mobile device system in which a mobile device 20 includes a RFID transmitter or transceiver can also be used in the mobile device payment system. Such a transceiver may be internal to the mobile device 20 such as those available in a subscriber identity module (SIM) card, and the transceiver can be controlled by and used with software and hardware components of the mobile device itself to perform steps discussed below for the external accessory 10 and the separate mobile device 20. Additionally, in another embodiment, an RFID transmitter or transceiver can be externally attached to a mobile device 20 and be controlled as well by and used with software and hardware components of the mobile device to perform these steps as well.

The mobile device payment accessory 10 including its stored control software 12 is directly connected, wirelessly or through a wired connection, to a mobile device 20 having a mobile device software application 22. The accessory 10 communicates wirelessly to a reader computer 40 which is a part of a merchant computer network system 50. The reader computer 40 has a transceiver 43 in this embodiment for transmitting and receiving wireless short range signals. Short range is less than a foot, in one example. The reader computer 40 also has stored on it software 42 for controlling the transfer of data received from the accessory 10 to the merchant computer network system 50.

One or more computers make up the merchant network system 50, and one or more of these computers can be executing software 52 during a transaction in which the software 52 communicates over the Internet 80 with software 32 of a payment service executing on one or more servers 30 of a payment service network.

The software 32 of the payment service communicates over the Internet with software 62 executing on one or more servers 60 of a payment account manager computer network system which manages a payment account for the user in order to request and receive payment approvals for the user's account.

The software 32 of the payment service communicates over a mobile communication network 90 with the mobile device application 22 to request and receive purchase approval. Of course, the payment service can notify the mobile device application 22 of any payment approvals and denials as well. A mobile communication network 90 is a network which the mobile device can support for accessing the remote payment service computer network system 30. For example, cellular transmission networks using Global System for Mobile Communications (GSM), Code Division Multiple Access (CDMA) or Short Message Service (SMS) would be an example of a mobile communication network 90. Another example would be a wireless network protocol such as any version in the IEEE 802 set of standards for wireless communication, examples of which are the 802.11 set and the 802.16 set which includes Worldwide Interoperability for Microwave Access (WiMax). In other examples, the mobile device 20 can communicate with the payment service network 30 over a wired communication network 90 via a wired connection, for example an Ethernet port as well.

FIG. 5A illustrates an example embodiment of a reader computer system 40 including computer hardware and software components. The system 40 comprises a processing unit 502 including local memory 504. The processing unit 502 can comprise one or more processors. The local memory 504 can embody various cache designs to assist the one or more processors in the processing unit 502 with faster execution of instructions.

Communication bus 506 provides a communication path between the various system components. For example, the bus 506 provides the processing unit 502 with access to memory controller 508, which controls access in this example to volatile memory 510 and non-volatile memory 512. The memory 510 is representative of the volatile storage such as random access memory (RAM) in its various technology implementations (DRAM, SRAM, etc.). Some examples of temporary data stored in volatile memory is data for use when an application is executing in the processing unit 502 and what is currently displayed on a computer screen. Non-volatile memory system 512 is representative of memory for storing items even when the reader computer system 40 is turned off. Some examples of such non-volatilely stored data are applications such as the operating system 518, the reader application 42, other software applications 516 and reader identification data 514 to uniquely identifier this reader.

The system 40 further comprises a display driver 520 to control a display 522 and an input device driver 524 for interpreting the keystrokes and touches a user enters on a keypad and/or touchscreen 526 typically associated with a reader.

In this example, the reader computer 40 includes an RS-232 communication interface 528 to a cash register computer 530 of the merchant computer network system.

One or more network interface(s) 532 are also provided so that the reader system 40 can communicate with one or more computer networks such as the merchant network system 50. The interface(s) 532 can include wired, wireless or both.

The reader computer 40 further comprises a transceiver interface 534 to interface between digital format of data for the processing unit 502 and the transmission signals of the transceiver unit 43 which transmits a vicinity signal to indicate its presence to a device like the accessory 10 from which the transceiver unit 43 receives data for completing a transaction.

FIG. 5B illustrates an example embodiment of a mobile device computer system 20 including computer hardware and software components. The system 20 comprises a processing unit 501 which can comprise one or more processors and includes local memory 505, which can embody various cache designs.

Communication bus 507 provides a communication path between the various system components. For example, the bus 507 provides the processing unit 501 with access to memory controller 509, which controls access in this example to volatile memory 511 and non-volatile memory 513. Some examples of such non-volatilely stored data are applications such as the operating system 519, the mobile device application 22, other software applications 517, an audio signal encoder 503 in this example, a mobile device encryption data 547 received from the payment service, other payment service data items for the mobile device 531, and data items 533 from the payment service for the accessory. These are just examples of items that can be stored in memory and the memory of course comprises other data and software.

The system 20 further comprises in this example a display and user interface driver 521 to process the input from the touchscreen 5 and update the touchscreen display 5 for applications executing on the mobile device.

This embodiment illustrates a device connection port 541, for example, a USB port, for attaching to another computer system such as the accessory 10 via its external input communication interface 202. Furthermore, this embodiment includes a wireless communication interface port 545 for connecting wirelessly with a device such as the accessory 10 via its interface 202. Some examples of a wireless communication protocol that can be used are Bluetooth.

This mobile device embodiment 20 also includes one or more network interfaces 539, which can be wired or wireless, for Internet access via computer Internet protocols such as Ethernet or a version in the IEEE 802 set of standards for wireless communication, some examples of which are the 802.11 set and the 802.16 set which includes Worldwide Interoperability for Microwave Access (WiMax).

In this example, an audio driver 543 receives data 533 for transfer to the accessory 10 over bus 507 under the control of the mobile device application 22 in a digital format and generates an analog signal based on the digital format for transfer to the audio output port 15. As in the example of FIG. 1, the audio output port 15 can be an earphone jack. The audio driver 543 would also process audio input such as from a microphone received from an audio input port 549.

This embodiment comprises various communication interfaces for communicating with the accessory for illustrative purposes. A mobile device having only one of these communication interfaces can initialize the accessory.

The mobile device also has a telecommunications transceiver interface 535 for interfacing with the telecommunications transceiver unit 537 which provides the physical interface to one or more wireless mobile communication networks 90 used by the mobile device.

In different embodiments, the accessory 10 can be embodied internal to the mobile device 20. FIG. 5C illustrates another example embodiment of a mobile device computer system in a block diagram view comprising an internal RFID transceiver 540. FIG. 5C is very similar to the embodiment of FIG. 5B except that the device connection port 541 was removed for illustrative convenience to show an RFID transceiver 540 communicatively coupled to an antenna 542. As mentioned, the RFID transceiver 540 can be implemented in the SIM card. In some embodiments, an antenna 542 for some mobile devices is the body of the device itself. This embodiment includes a version of the accessory software 12a for performing at least some of the functions such as triggering transmissions by the RFID transceiver 540 as would be performed for an external device. Other functions directly related to disconnection of the external accessory would not be included. Other functionality may be included such as a user entering a transaction password as a prerequisite to the RFID transmitting transaction data to a reader terminal 40 as a precaution against unauthorized use.

FIG. 5D illustrates an example embodiment of a merchant computer system 50 including computer hardware and software components. The system 50 comprises a processing unit 552 which can comprise one or more processors and includes local memory 554, which can embody various cache designs.

Communication bus 556 provides a communication path between the various system components. For example, the bus 556 provides the processing unit 552 with access to memory controller 558, which controls access in this example to volatile memory 550 and non-volatile memory 562. Some examples of such non-volatilely stored data are applications such as the operating system 568, the merchant software 52, a database interface 582 for accessing one or more of the merchant's databases 584 via the merchant network 50, other software applications 566, and local merchant data items 564. These are just examples of items that can be stored in memory and the memory of course comprises other data and software.

The system 50 further comprises a display driver 570 to control display 572 and at least one input device driver 574 for interpreting input from input devices 576 like a keyboard and pointing device.

In this example, the merchant computer 50 includes an RS-232 communication interface 580 to a reader computer 40 of the merchant computer network system.

One or more network interface(s) 578 are also provided so that the merchant computer system 50 can communicate with one or more computer networks such as over the Internet 80 or access the one or more databases 584 over the merchant's internal network 50. The interface(s) 578 can include wired, wireless or both.

Some examples of data which the merchant databases 584 can include are product information including descriptions, prices, addresses of various merchant locations, unique identifiers for readers in various merchant locations, logistical information for transactions completed, customer transaction histories, payment provider identifications, and merchant identifications to name a few.

FIG. 5E illustrates an example embodiment of a payment service computer system 30 in the payment service computer network 30 including computer hardware and software components. The system 30 comprises a processing unit 553 which can comprise one or more processors and includes local memory 555, which can embody various cache designs.

Communication bus 557 provides a communication path between the various system components. For example, the bus 557 provides the processing unit 553 with access to memory controller 559, which controls access in this example to volatile memory 551 and non-volatile memory 563. Some examples of such non-volatilely stored data are applications such as the operating system 569, the payment service software 32, a database interface 581 for accessing one or more of the payment service databases 583 (PS DBs) via the payment service network 30, and other software applications 567. These are just examples of items that can be stored in memory and the memory of course comprises other data and software.

The system 30 further comprises a display driver 571 to control display 573 and at least one input device driver 575 for interpreting input from input devices 577 like a keyboard and pointing device.

The payment service system 30 also has a telecommunications transceiver interface 585 for interfacing with a telecommunications transceiver unit 587 which provides a physical interface to one or more wireless mobile communication networks 90 used by the mobile device 20.

One or more network interface(s) 579 are also provided which the payment service computer system 30 can use to communicate with the merchant system 50 and the one or more payment account manager systems 60 over the Internet 80. Additionally, the payment service computer system 30 can access via a network interface 579 the one or more databases 583 over the payment service network 30. The interface(s) 579 can include wired, wireless or both.

Some examples of data which the payment service databases 583 can include are user account identifications, accessory identifications, payment accounts associated with each user account identification, accessory encryption keys or seeds or other types of encryption related values, mobile device encryption values, account usernames and passwords, customer transaction histories, merchant identifications and merchant encryption values to name a few.

The payment account manager computer systems 60 of its network include many of the hardware and software components similar to the servers used by the merchant 50 and payment service 30 systems.

The various types of memory, both non-volatile and volatile, and removable storage media (e.g. disks, memory sticks, etc.) are examples of computer-readable storage media having encoded or stored thereon computer-executable instructions for performing various methods in accordance with embodiments of the technology described in this specification.

FIGS. 5F and 5G illustrate some examples of modules or sub-components which may exist in either the mobile device application or the payment service software. These are for illustrative purposes only and are not meant to be limiting of the technology. As mentioned below, the particular naming and division of modules, routines, features, attributes, methodologies and other aspects are not mandatory, and the mechanisms that implement the technology or its features may have different names, divisions and/or formats.

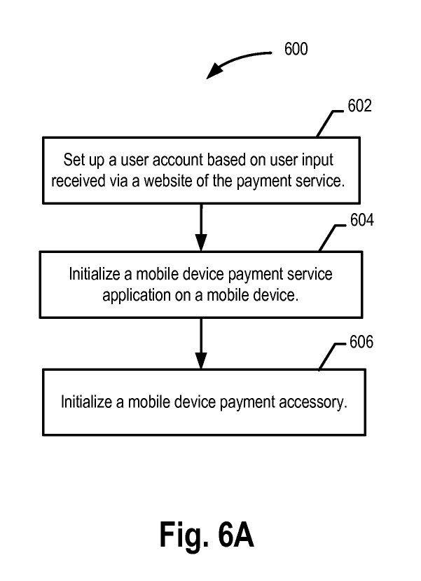

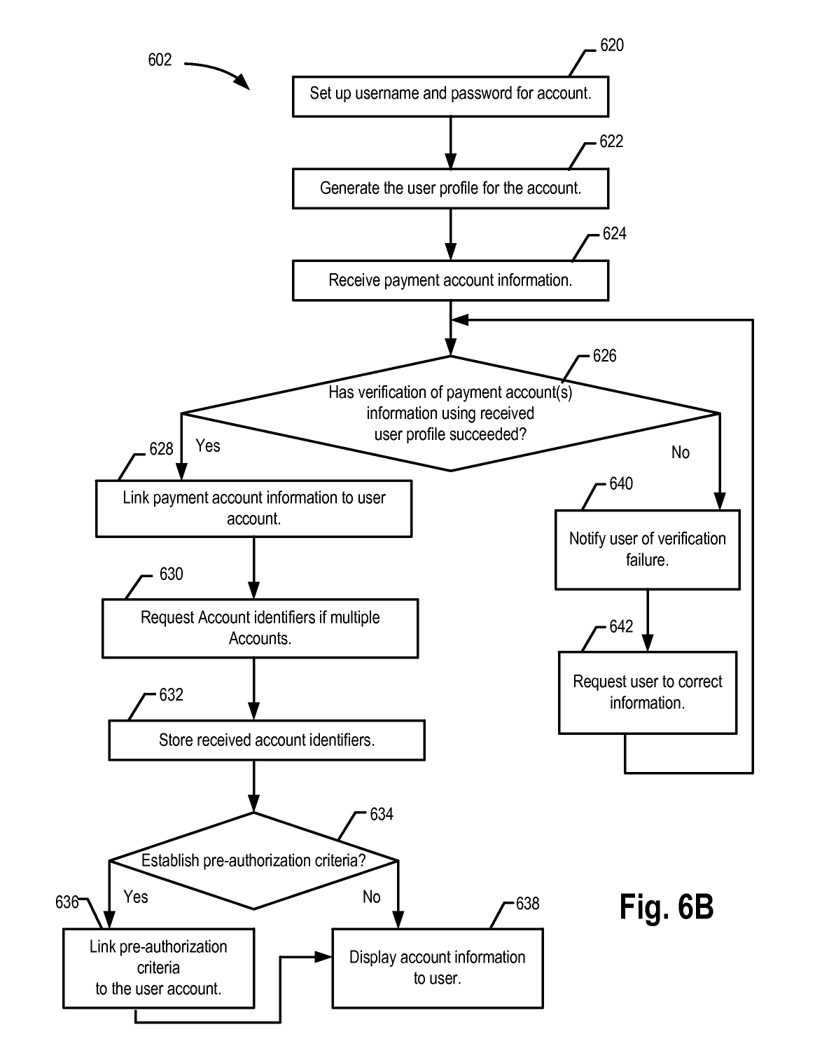

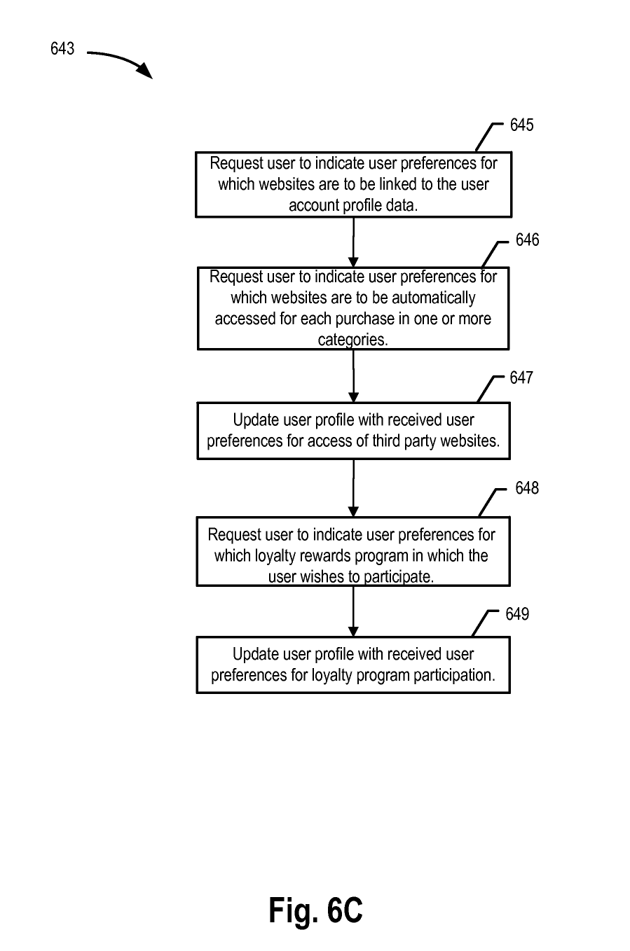

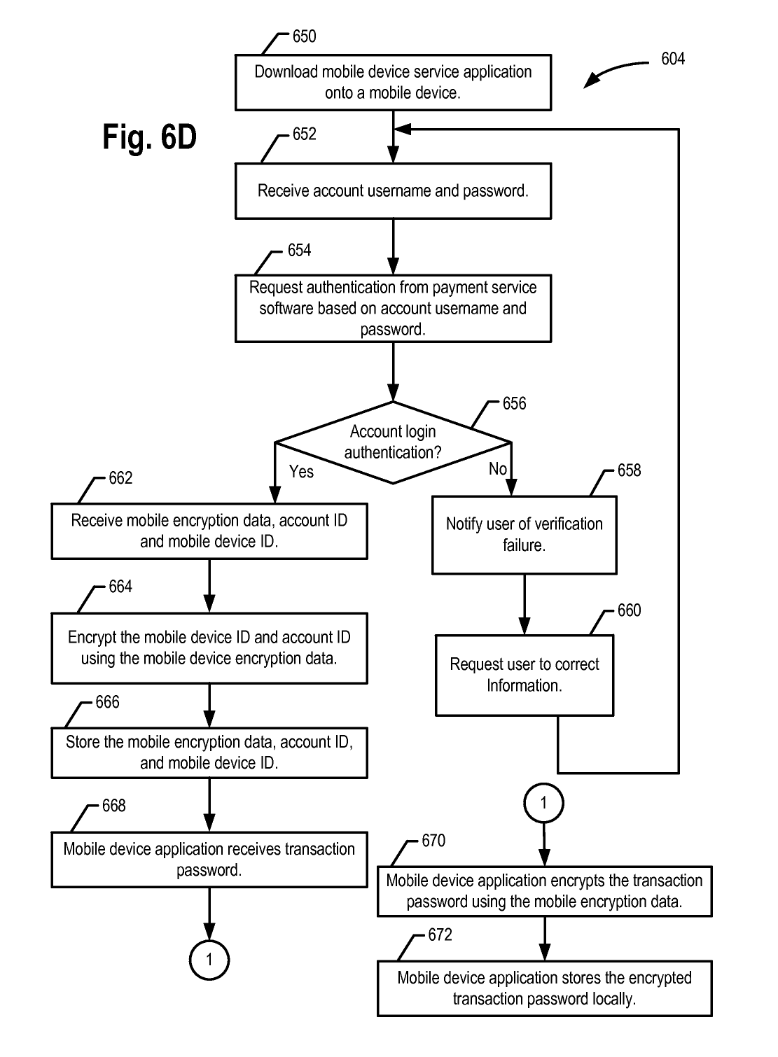

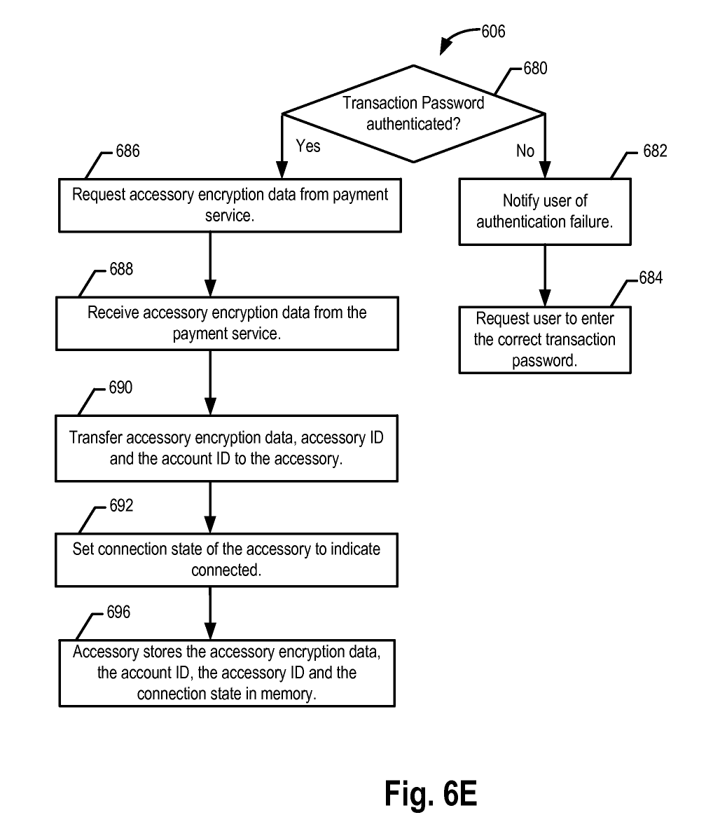

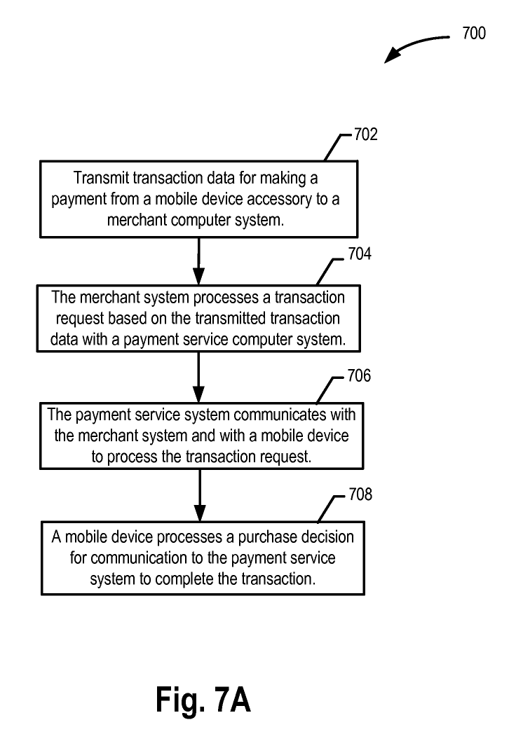

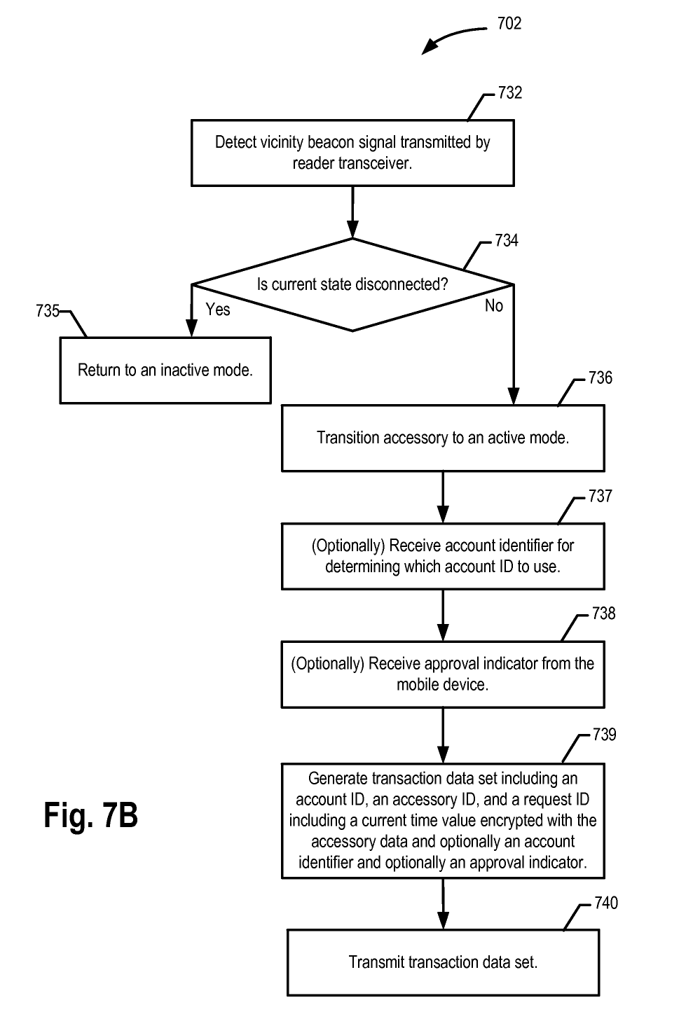

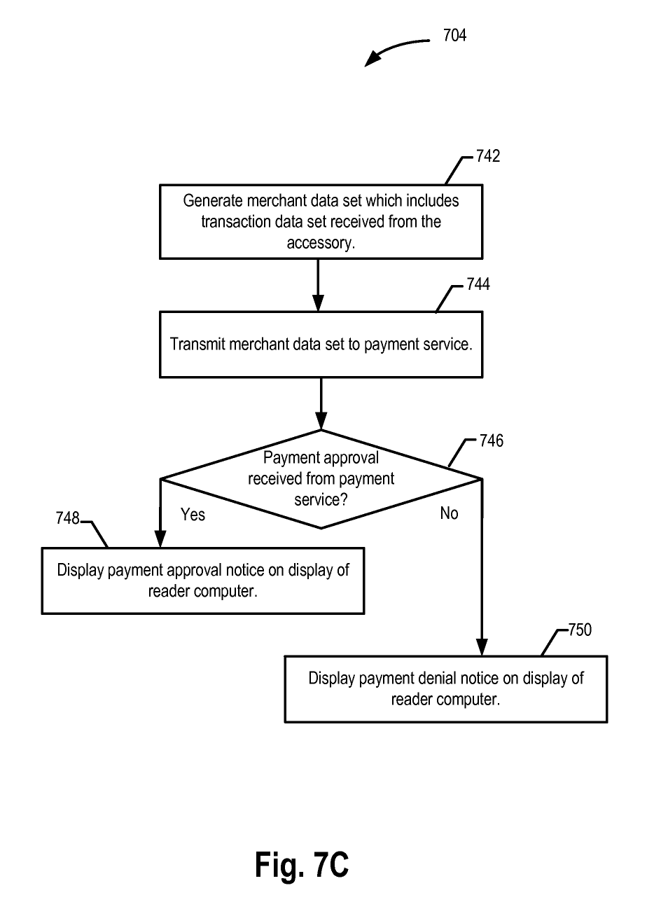

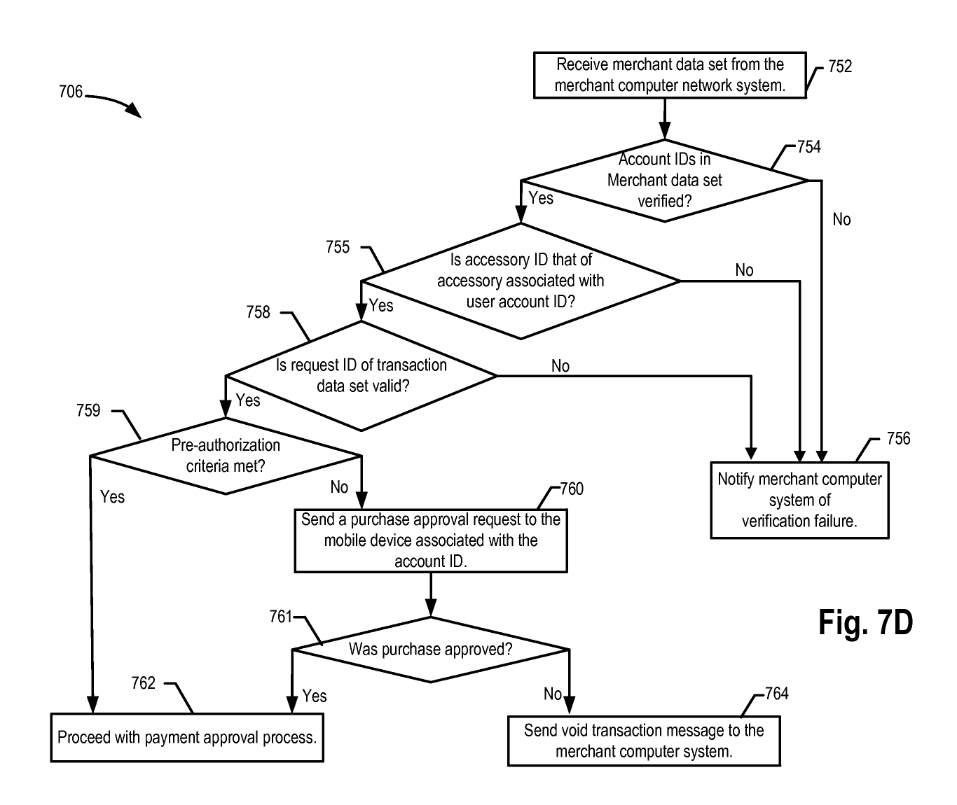

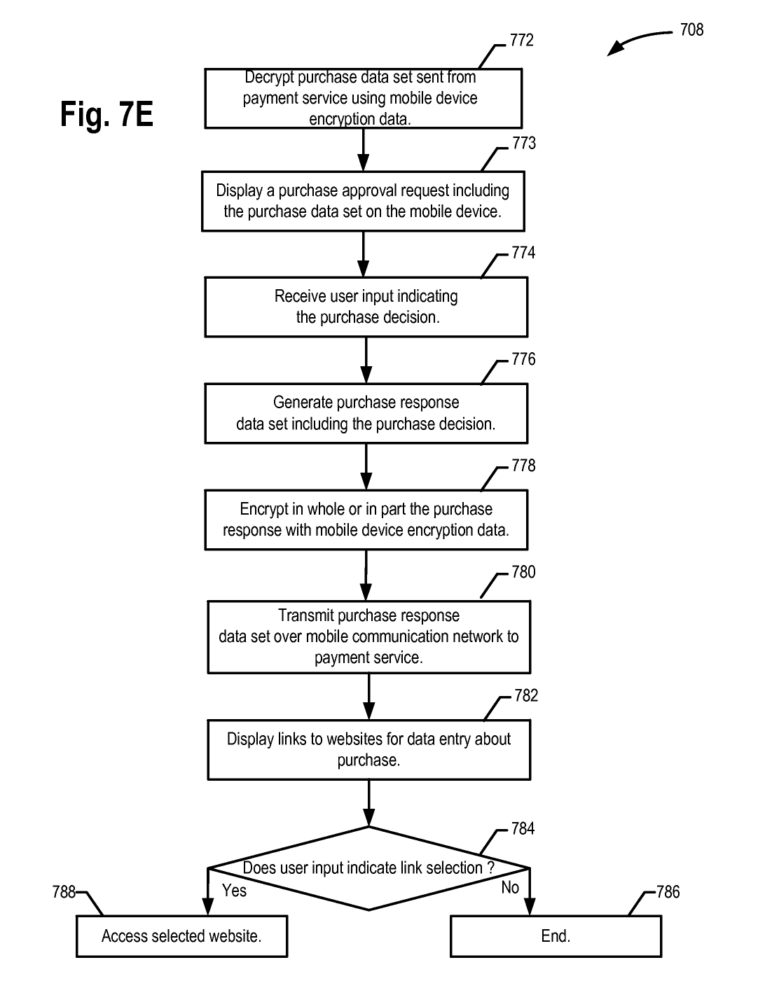

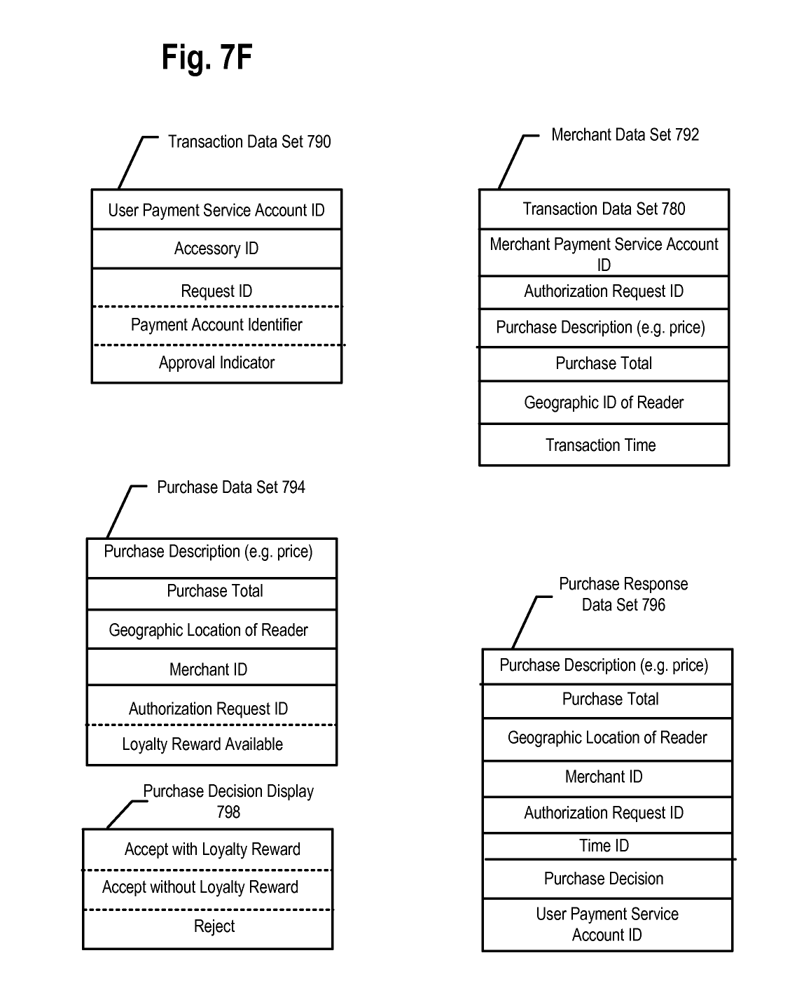

FIG. 5F illustrates an example embodiment of software components which may be included in a mobile device software application 22. The software modules comprise a login module 588 which processes authentication requests for passwords such as the local mobile device password in the payment system discussed below. The login module 588 also processes logins to the user's payment service account from the mobile device 20. A notification module 589 processes incoming messages, for example, a purchase approval request from the payment service, and directs them to the appropriate module for processing. A purchase confirmation software module 590 processes the response to the purchase approval request as may be done in the example processing of FIG. 7E discussed further below. For example, the purchase confirmation software 590 sends the response to the payment service system 30 with a purchase decision as discussed further below in the example of FIG. 7E. An account management module 591 processes, for example, a user interacting with the payment service system 50 for updating account features or in the initialization process of the mobile device as in the exemplar processing of FIG. 6D or the initialization procedure of the accessory as in the exemplar processing of FIG. 6E discussed further below. Of course, the mobile device application 22 can include other software for performing other functions as well.

FIG. 5G illustrates an example embodiment of software components which may be included in the payment service software 32. The message retrieval module 592 can communicate with the merchant system 50, the mobile device 20 and the payment account manager computer system 60 to receive and sort messages from these computer systems and route them to modules of the payment service software 32 which process specific types of messages. The message validation module 593 can detect invalid messages from other computer systems and notify those computer systems of errors in the messages.

The account management module 594 controls the data entered and retrieved from a user's payment service account. This module 594 may perform many of the steps for setting up a user's profile and account as discussed in the example of FIG. 6A. The account management software module 594 manages updates to the account data as purchases and payments are made as in the method embodiments of FIGS. 7A through 7E. A payment account module 597 can interact with the payment account manager system 60 associated with the account of a user and update specific payment related data associated with a user's account.

The transaction request module 595 may perform many steps for formulating requests for approval of a requested transaction as in the example of FIG. 7D discussed further below and notifies the account management module 594 of responses. Based on a user's approval of the requested transaction on his or her mobile device, the transaction request module 595 can interact with the account management module 594 to verify criteria for a transaction is satisfied and complete or void a transaction. The request validation module 596 may perform steps related to encrypting and decrypting data as in the examples of FIGS. 7B through 7E to ensure the requested transaction being processed by module 595 is valid.

The following method embodiments are discussed in the context of the systems of the previously described figures for illustrative purposes only and not to be limiting thereof.

FIG. 6A is a flowchart illustrating one embodiment of a method 600 for setting up user access to a mobile device payment system. Using user input received via a website of the payment service system 30, the payment service software 32, for example using at least in part account management module 594, in step 602 sets up an account for the user. Based on user input, the mobile device payment service application 22 in step 604 initializes itself on a mobile device in interactions with the payment service software 32. In step 606, the mobile device application 22 executing on the mobile device 20 initializes the mobile device payment accessory. Each of these steps is illustrated further in the examples of FIGS. 6B to 6E.

FIG. 6B is a flowchart illustrating one embodiment of a method 602 for setting up an account with a payment service website. A user accesses a website on which the payment service software 32 is executing via a browser or other software which can access the payment service's computer network system 30. The user enters a username and password in a webpage, and standard account login creation software of the payment service software 32 can be used to set up the account login username and password in step 620.

The service, software 32, requests a user to enter user profile data, for example, via text entry boxes on a webpage and processes the data to generate in step 622 the user profile data for the account. Some examples of user profile data are a birthday, name, tax identification number, and an address. Additionally, the user can be requested to identify third party websites to link to the payment service account. One example of third party websites are social networking sites such as Facebook®, Twitter® and Foursquare™. Another is customer feedback sites such as Yelp® and other examples include loyalty rewards programs which provide discounts and free merchandise and services based on a customer's purchases. These websites are linked to the user profile data, and the user can indicate that they be automatically accessed after each purchase.

The payment service software 32 requests payment account information, for example via text boxes on a secure webpage. Some examples of a payment account are a credit card account, a debit card account, a bank account or a cash account like a PayPal® account managed by third parties. The payment service can also provide these types of payment account to its users and perform payment approval processing within its own network of computers 30. Responsive to receiving from the user payment account information in step 624, the software 32 uses the user profile data in step 626 to verify the one or more payment accounts with software 62 executing on one or more payment account manager computer network systems 60 which manage the one or more payment accounts the user entered.

Responsive to receiving a notification of verification failure for a payment account from a payment account manager software 62, the service software 32 notifies the user of the verification failure in step 640, for example via a webpage display and requests the user to correct entered information in step 642.

Responsive to receiving a notification of an account verification from the payment account manager software 62, the service software 32 links the payment account information with the user's payment service account, for example, via the user profile data for the account stored in database 583 in step 628.

Optionally, if more than one payment account is to be used with the accessory, the payment service software 32 can request account identifiers in step 630 to distinguish between accounts at transactions, and store the received account identifiers in step 632 for the user account, for example in the user profile data.

Furthermore, the user can establish pre-authorization criteria for transactions which if satisfied causes the payment service to not send a purchase approval request to the mobile device before a transaction is completed. For example, if a user is going to be in an area with poor cell coverage for a few days, the user can update her account to indicate a length of time for pre-authorization to be in effect or a geographic area in which it is to be in effect. As discussed further below, the geographic area can be identified by an identifier of a reader computer system. Additionally, a price limit can be established below which, or above if the user desires, a pre-authorization request to the mobile device is not performed.

Upon determining in step 634 the user has established pre-authorization criteria by entering data, the payment service software 32 links in step 636 the received pre-authorization criteria to the user account, for example in the user profile data for the account, in the database 583. If the user has not entered pre-authorization criteria or after he has, the payment service in step 638 displays the user payment service account information for the user to view, for example on a webpage.

In some examples, the processing of FIG. 6B can include linking the user account with third party services. FIG. 6C is a flowchart illustrating a method embodiment for linking third party services with the user payment service account. The service software 32, for example the account management software module 594 executing on a processor 553 of a payment service computer 30 in the network 30, requests in step 645 the user to indicate user preferences for which websites are to be linked to the user account profile data and requests the user in step 646 to indicate user preferences for which websites are to be automatically accessed for each purchase in one or more categories. For example, the user may indicate that restaurant purchases automatically cause access to a customer feedback website such as Yelp or a specific restaurant review website. The user can also indicate that no websites be linked to the account or that no websites identified in the user profile be automatically accessed. Some users may indicate preferences that one or more sites be automatically accessed for each purchase. In step 647, the software 32 (e.g. 594) updates the user profile with the received user preferences for access of third party websites.

Additionally, the software 32 in step 648, requests user to indicate user preferences for which loyalty rewards program in which the user wishes to participate. The payment service software 32 may present a display with various merchants programs to choose from and may all provide the ability to select all of them. Additionally, the user may select to have the loyalty rewards programs linked to the user profile automatically updated as new loyalty programs are made available through the payment service 32. In this way, the user no longer needs to worry about having cards issued by the merchant or remembering to ask for a reward before a transaction to obtain a discount or free merchandise as the payment service 32 processes a request automatically in the transaction. The merchant benefits also by not having to issue cards for mobile device users. The software 32 in step 649 updates the user profile data with the received user preferences for loyalty program participation.

FIG. 6D is a flowchart illustrating one embodiment of a method 604 for setting up a mobile device payment service application on a mobile device. From the mobile device 20, a user accesses the payment service software 32 over a mobile communication network 90 and downloads in step 650 the mobile device service application 22 onto the mobile device. The user enters the account username and password created at the payment service website into the mobile device to be received in step 652 by the mobile device application 22. The mobile device application 22, for example login module 588, accesses the payment service software 32 over the mobile communication network 90 and sends the account username and password to request in step 654 authentication from the payment service.

If it is determined in step 656 that the account login authentication failed, the mobile application 22 notifies the user in step 658 of the verification failure on a display of the mobile device, and in step 660 request the user to correct the information.

Responsive to the account username and password being authenticated, the mobile device application 22 in step 662 receives from the payment service software 32 mobile encryption data including a mobile encryption value, for example a seed or a key, and a data set including a mobile device identification (ID) and an account identification (ID) for the user's payment service account. The account ID can include an account number. Other information to be included in the account ID or sent additionally can be a name and other metadata. In one example, the mobile ID is a logistical item such as a time of transmission of the mobile encryption data or value from the payment service system. Some other examples of data which may be or which can be included in the mobile ID is a random number, a name, metadata, account number or other logistical data. One or more of these examples and other items can be concatenated for as well for the mobile ID.

In step 664, the mobile device application encrypts the mobile ID and the account ID, using the mobile device encryption data (e.g. the encryption value) to generate a mobile device identification (ID).

In step 666, the mobile device application 22 stores the account ID, mobile device ID and the mobile encryption data in the memory of the mobile device.

The mobile device application 22 requests the user to enter a transaction password via a display, and the mobile device application 22 receives the transaction password via user input in step 668, encrypts it in step 670 with the mobile encryption value and stores the encrypted password locally in step 672. In other embodiments, the password can be stored in an accessible memory which is remote from the mobile device.

The encryption data for any of the devices or systems such as the accessory, mobile device, or the merchant system can include one or more encryption values such as a seed or key or other encryption code. A seed may be a number used to initialize a pseudorandom number generator. Having a seed allows one to obtain a secret encryption key which is pseudorandomly generated. A secret key can be the same random seed deliberately shared between two or more systems using matching pseudorandom number algorithms as matching seeds can generate matching sequences of numbers. In some embodiments, the encryption value can be a random seed generated from the state of the payment service system such as a time. An example of a time is a time of transmission of a seed or key.

Either symmetric or asymmetric encryption algorithms can be used. In symmetric, the same key or two keys, at least one of which can be determined from the other is used for both encryption and decryption. Some symmetric-key algorithms are stream ciphers or block ciphers. An example of an asymmetric algorithm is the commonly used public key encryption where each user has a public cryptographic key and a private cryptographic key. The public key is used to encrypt a message while the private key is used to decrypt the message. These public and private key pairs are related but unlike with a symmetric key, it is not generally feasible to derive a private key from the public key.

If the user has acquired the accessory and entered the transaction password in the mobile device, the user can connect the accessory and continue the mobile device application session started in FIG. 6D to initialize the accessory starting with a request for accessory encryption data from the payment service. Otherwise, the user can login into the mobile device application again with the transaction password and initialize the accessory.

FIG. 6E is a flowchart illustrating one embodiment of a method 606 for initializing the mobile device payment accessory which is a removable external accessory in this embodiment. In step 680, the mobile device application 22 authenticates the transaction password. Responsive to authentication failure, in step 682 the application 22 notifies the user of the authentication failure via a display 5 of the mobile device and requests the user to enter the correct transaction password in step 684.

Responsive to authentication success, in step 686 the mobile device application 22 requests encryption data which may include an encryption value for the accessory from the payment service software 32 over the mobile communication network 90. Some examples of an encryption value can be a seed or a key. The payment service 32 sends encryption data from the payment service which is received by the mobile device in step 688. As for the mobile ID, the accessory ID may be a logistical item such as a time of transmission of the accessory encryption data from the payment service system. Some other examples of data which may be or which can be included in the accessory ID is a random number, a name, metadata, account number or other logistical data. One or more of these examples and other items can be concatenated for as well for the accessory ID.

In some examples, an identification of which encryption algorithm to use with the key or seed is also sent in the encryption data. For example, in the case of an encryption seed, an identification of a pseudorandom number generator scheme may be identified. The payment service may use different encryption schemes with different accessories as an additional security feature. Accessory software 12 can include software for more than one type of encryption algorithm. In other embodiments, the payment service does not send an encryption algorithm identifier as an accessory is known to only have software for one scheme, but sends a value appropriate for that encryption algorithm

In step 690, the mobile device application 22 transfers the accessory encryption data, the accessory ID and the account ID to the accessory software 12 within accessory 10 via the earphone connector or other communication interface 202 examples as described above. The mobile device application 22 also sends a connection state indicator to the accessory software 12 to set the connection state of accessory 10 to indicate connected in step 692. The accessory software 12 stores the account ID, accessory ID, the accessory encryption data and the connection state in its memory system 214 in step 696. In other embodiments, the accessory software 12 can set the connection state to indicate connected based on a trigger such as storing the accessory ID, accessory encryption data and account ID.

FIG. 7A is flowchart illustrating one embodiment of a method 700 for making a payment using a mobile device payment system. In step 702, the mobile device accessory 10 transmits transaction data for making a payment to a merchant computer system 50, for example via reader 40. In step 704, the merchant system 50 processes a transaction request based on the transmitted transaction data with the payment service computer system 30, which in step 706 communicates with the merchant system and with a mobile device 20 to process the transaction request. In step 708, the mobile device processes a purchase decision for communication to the payment service system to complete the transaction. Each of these steps is discussed in further detail in the examples of FIGS. 7B through 7F. Furthermore, FIGS. 7B through 7F are flowcharts illustrating examples for making a payment using the mobile device payment accessory from the perspective of the different computer systems involved.

FIG. 7B is a flowchart illustrating one embodiment of a method 702 for making a payment using the mobile device payment accessory from the perspective of the accessory. In order to save power, a payment accessory 10 can be in an inactive mode such as a sleep mode and transition to an active mode for the relatively short interval for transferring data in a purchase. A wake-up signal triggers the mode change. In step 732, the transceiver 208 detects a vicinity beacon signal which acts as a wake-up signal, transmitted by a transceiver 43 of a reader computer system 40, and notifies the processor 204.

The accessory software 12 executing on the processor 204 determines in step 734 a current connection state of the accessory 10. If the state is disconnected, the accessory software 12 causes the processor to return the accessory 10 to an inactive mode such as a sleep mode in step 735. Although a payment accessory 10 is connected to a mobile device, its state can still be disconnected because once the accessory has been disconnected, establishing a physical, be it wired or wireless, connection with a mobile device does not by itself make the payment accessory operable again. The user must go through the initialization procedure such as that described in FIG. 6E in order to make the accessory 10 operable, most likely with new encryption data and a new accessory ID. Responsive to the connection state being connected, the accessory software 12 causes the processor 204 to transition the accessory 10 to an active mode in step 736.

Optionally, in the case of multiple payment accounts being associated with the accessory, the user can input an account identifier on the mobile device using the mobile device application 22 which is transferred to the accessory software 12 via the earphone jack or other communication means. In step 737, the accessory software 12 receives the account identifier and determines which payment service account ID to use. For example, the memory system 214 can store a look-up table matching account identifiers with account IDs.

Optionally, an approval indicator for the transaction can be received in step 738 to negate the need for a message from the payment service requesting approval of the transaction. The user may be in a situation where he or she did not set up pre-authorization criteria covering his or her current circumstances, but the user desires to pre-authorize the transaction at the point of purchase. For example, the user is in a location where cell coverage is unexpectedly experiencing a network failure, and the user will not be able to respond to a purchase approval request to complete a purchase.

A user can initiate the generation of an approval indicator by entering the transaction password into the mobile device 20 and indicating via user input such as selection in a menu or a display icon caused to be displayed by the mobile device software 22 a request to generate an approval indicator, for example an approval code. The software 22, for example the payment confirmation software 590, in one example, requests the user to enter at least one transaction related item such as the purchase total. It may also request another authorization identification (ID) or other ID generated by the merchant system 50 and displayed on the display 522 of the reader computer system 40. Responsive to the user entering the price and authorization ID, the payment confirmation software 590 generates an approval code. In one example, the approval code is a hash of a concatenation of the price, a current time truncated to a resolution level and the authorization ID. Other user profile data such as the account ID could be used as well. The approval indicator may be encrypted with the mobile device encryption data. The approval indicator can be automatically uploaded after generation or the user can initiate the upload into memory 214 of the accessory 10 by selecting a display indicator or other user input.

In one embodiment, as another security feature, the accessory stores the encrypted approval indicator for a limited period of time. The processor 204 can start a timer upon upload. Once the time period expires, the accessory processor 204 erases the approval indicator. Therefore, the user must swipe the reader with the accessory 10 quickly within the time limited period, for example 10 seconds, after uploading the approval indicator to complete the transaction.

In step 739, the accessory software 12 generates a transaction data set. One data item of the transaction data set is a request ID which is a current time value encrypted with the accessory encryption data, for example in calculation based on an accessory seed value. The clock of the accessory processor 204 can provide a time. As all the computer systems involved in a transaction may not be exactly synchronized, the current time value can be truncated to achieve a resolution level such as, for example, to the nearest 5 or 10 seconds.

FIG. 7F illustrates an example 790 of a transaction data set. The transaction data set 790 includes data items of the user payment service account ID, the accessory ID, a request ID, and optionally a payment account identifier to identify which payment account to use for this particular transaction and also, optionally an approval indicator. A default payment account identifier can be used if one is not identified. In some examples, these other data items are encrypted with the accessory encryption data as well.

In step 740, the accessory software 12 causes the processor 204 to instruct the transceiver 208 to transmit the transaction data set to the transceiver 43 of the reader computer system 40 which forwards the transaction data set to a computer of the merchant computer network system 50 for further processing.

FIG. 7C is flowchart illustrating one embodiment of a method 704 for making a payment using the mobile device payment accessory from the perspective of the merchant computer network system 50. The merchant software 52 executing on one or more computers in the system 50 begins the processing of a transaction request initiated by the transmission of a transaction data set by the accessory 10 by generating in step 742 a merchant data set which includes the transaction data set received from the accessory. FIG. 7F illustrates an example 792 of a merchant data set, which in addition to the transaction data set 790 includes data items of a merchant payment service account identification (ID) with the payment service, an authorization request identification (ID) for the purchase being made, a purchase description, a purchase total amount, a geographic identification (ID) of the reader, and a transaction time.

The transaction time can be the time, to a predetermined resolution, the reader 40 received the transaction data set from the payment accessory 10 so that it can be compared for verification with the current time value encrypted in the request ID of the transaction data set transmitted by the accessory 10.

The purchase description can include an itemized list of the purchase items including a description of the items and their price. The geographic identification of the reader can include an identifier into a look up table of merchant address locations and another identifier into another look-up table of identifications of the specific readers 40 within the location.

In step 744, the merchant software 52 transmits over the Internet 80 the merchant data set to the payment service software 32 executing on one or more servers 30 of the payment service network. The transmission can be using a secure transmission protocol, for example secure sockets layer (SSL). Additionally, the merchant's software 52 can encrypt the data partially or in whole as well. For example, a merchant seed or key shared with the payment service can be used to encrypt the transaction time.

The merchant system then checks in step 746 whether a payment approval has been received from the payment service system 30 after that system 30 performs the processing embodiment of FIG. 7D described below. If the payment is approved, a payment approval notice will be displayed in step 748 on a display 522 of the reader computer system 40. If the payment approval is denied, a payment denial notice will be displayed in step 750 on the display 522 of the reader computer system 40.

FIG. 7D is flowchart illustrating one embodiment of a method 706 for making a payment using the mobile device payment accessory from the perspective of the payment service computer network system 30. In this embodiment, the payment service system 30 is communicating with the merchant system 50 and the mobile device 20 to process the transaction. In step 752, the payment service software 32 executing on one or more servers 30 of the payment service computer network system receives the merchant data set from the merchant system 50 and in step 754, verifies both the merchant payment service account ID and the user payment service account ID. Responsive to a failure of verification for either, the payment service software 32 causes in step 756 a verification failure message of which account IDs failed to the merchant system software 52.

If the account IDs are verified, the payment service software 32 in step 755 determines whether the accessory ID is the accessory ID associated with the user account ID. In one embodiment, it decrypts the accessory ID with the accessory encryption data, for example an accessory encryption value, stored in its memory which it previously sent in the accessory initialization procedure. If there is a match between its stored version of the unencrypted accessory ID and that decrypted in the accessory ID of the transaction data set, the verification process moves on to the request ID. Again, if not a match, the verification failure notice message is sent in step 756 with an indication that the accessory ID did not match.

In 758, the payment service software 32 determines whether the request ID of the transaction data set is valid. For example, the payment service software 32 can use the transaction time of the merchant data set to determine if the request ID was made by the accessory for this transaction. This is to avoid allowing a purchase using an electronically swiped transaction data set later.

The payment service system uses the same resolution of the transaction time used by the accessory, for example time to the nearest 5 or 10 seconds as mentioned for the examples above. In one example, the payment service software 32 generates a number of codes using the accessory encryption data such as an encryption value it has stored to encrypt the transaction time in the merchant data set at a number of time values within a time window about the transaction time. The time window can be 5 seconds either way for example. There are three codes generated covering 10 seconds centered around the time of the merchant transaction time. The payment service software 32 then looks for a match of one of these encrypted values with the request ID in the transaction data set of the accessory which was included in the merchant data set. In another example, the payment service software 32 can decrypt the request ID using the its stored version of the accessory encryption data or accessory encryption value to see if the current time encoded is within the time window for the transaction time the merchant software 50 included in the merchant data set 792. If no match is found, the verification failure notice message indicating an invalid transaction time is sent in step 756. If a match is found, the payment system software 32 stores the matching request ID as an invalid matched code so that it cannot be used again as a fraud prevention measure.

Responsive to a valid request ID being associated with the transaction, the payment service software 32 checks in step 759 if pre-authorization criteria has been met. As mentioned above, some examples of pre-authorization criteria can be a price limit, a time period or a geographic location of the place of purchase. Additionally, an approval indicator sent in the transaction data set as in the example 790 indicates pre-authorization has occurred, and thus pre-authorization criteria satisfied. Responsive to the pre-authorization criteria being met, the payment service software 32 proceeds in step 762 with a payment approval process with software 62 executing in a payment account manager computer network system which manages the user's payment account identified with the user's payment service account. Responsive to the pre-authorization criteria not being met, the payment service software 32 causes a message requesting approval of the purchase and purchase data to be sent in step 760 to the mobile device 20 associated with the user payment service account ID over a mobile communication network 90.

As shown in the example of a purchase data set 794 of FIG. 7F, a purchase data set comprises the authorization request ID, the purchase description, purchase total, a merchant ID which can be a name of the merchant, and a geographic location of the reader which can be the store address or some other identifier a user would comprehend to indicate a specific geographic location. Optionally, if the user account profile indicates participation in loyalty programs, the service software 32 can automatically apply any savings to the purchase total if indicated in user preferences or notify the user of the reward as illustrated in this example 794. The user may then decide to use the reward at the current time or bank the reward as may be allowed by the entity such as a merchant controlling the loyalty program. For example, the reward may be a free bakery item in a coffee shop, and the user is not hungry at the time of purchase. Part or all of the data items can be encrypted by the payment system software 32 using the mobile device encryption value sent during the set up process with the mobile device 20.

The message requesting approval of the transaction can take different forms as different mobile devices have different capabilities. For example, the message can be a voice message with an interactive menu to let the user hear the description of the purchase and respond with a purchase decision. In other examples, the message can take the form of an e-mail message, a webpage, a display view generated by the mobile device application 22, or a text message.

The payment service software checks in step 761 whether the mobile device 20 has sent a message response indicating the purchase was approved or rejected after the mobile device 20 has performed the purchase approval processing such as in the embodiment of FIG. 7E described below. If the purchase is approved, a payment service software 32 proceeds in step 762 with a payment approval process with software 62 executing in a payment account manager computer network system which manages the user's payment account identified with the user's payment service account. The payment approval may be for a modified purchase total which the user has edited as discussed below or may have been modified if the user confirmed acceptance of the loyalty reward. If the payment approval is rejected, a message requesting to void the transaction is sent in step 764 to the merchant software 52 executing in the merchant computer network.

FIG. 7E is a flowchart illustrating one embodiment of a method 708 for making a payment using the mobile device payment accessory from the perspective of the mobile device 20. References are made to the software modules of FIG. 5G for illustrative purposes only and not to be limiting of how the technology is implemented. In this embodiment, the mobile device 22 software, for example purchase confirmation software 590, alerts the user to the request for payment approval and communicates a purchase decision to the payment service system 30. The mobile device 20 receives the purchase data set 794 over the mobile communication network 90 such as a cellular network. In step 772, the mobile device application 22, for example the message validation module 593 decrypts the encrypted portion of the purchase data set using the mobile device encryption data and in step 773, the purchase confirmation software 590 displays the purchase approval request including the purchase data set on the mobile device 20. Via a display, the purchase confirmation software 590 requests user input indicating approval or rejection of the purchase.

The user can indicate approval of the transaction by entering the transaction password which can be locally stored. The user can indicate rejection by hitting a reject button. In another example, the user enters the transaction password in order to enter an approval or a rejection decision. The purchase confirmation software 590 receives in step 774 user input indicating the purchase decision and generates in step 776 a purchase response data set including the purchase decision. The example 796 of a purchase response data set of FIG. 7F comprises the data items of the purchase data set 794 plus a time identifier ID for a current time, the purchase decision, and the user payment service account ID. A purchase decision can include whether or not to apply a loyalty reward for a transaction. In one example, a display 798 with touch selectable display areas is generated by the purchase confirmation software 590 for requesting user input on accepting the purchase with or without application of the loyalty reward or to reject the transaction. In other examples as discussed below, the display is editable to also change the purchase data including a purchase total. User input is received and processed by the purchase confirmation software 590 to generate a purchase decision.

The purchase response data set can be encrypted in step 778 in whole or in part with the mobile device encryption data. For example, the time ID representing a current time plus a price in the purchase description or a purchase total plus the merchant ID can be concatenated and encrypted with the mobile device encryption data, for example using an encryption value. Other combinations of data items can be encrypted as well. The purchase confirmation software 590 transmits in step 780 the purchase response data set over the mobile communication network 90 to the payment service software 32 executing in the payment service computer network system 30. The payment service software 32 can decrypt the purchase response message. It can use a time window to determine if the response is within an allowable response time period. The price, particularly of a particular item in the purchase, is another source of verification indicating it is for the same transaction as for the authorization request. Being able to decrypt using the mobile device encryption data such as a key or a seed is another source of verification that the user associated with the account is making the purchase decision.

The payment service software 32 can use the authorization request ID to match the purchase response data set to an outstanding authorization request from a merchant, and proceed (step 762 in FIG. 7D) with payment processing or voiding the transaction (step 764 in FIG. 7D) responsive to the purchase decision data item.

In one embodiment, if the payment service does not receive a response from the mobile device using one mobile communication protocol over the mobile communication network 90, it can try another mobile communication protocol. For example, if an IEEE 802 protocol (e.g. WiFi) based connection failed or a cellular voice transmission protocol failed, a protocol such as Short Message Service (SMS) can be used for a text based message such as an e-mail or a text message. For example, if a timeout error is received at the payment service software 32 regarding a sent purchase data request, the payment service software 32 can send it in a text based message such as an e-mail or a text message. The user can then manually open the mobile device application 22 to enter the transaction password, and manually enters a price to pay. The mobile application 22 generates an approval indicator such as an approval code by encrypting the price entered and a time ID like a current time with the mobile device encryption data. The user then pastes the approval code in the text message reply. In some cases, the purchase confirmation software 590 can generate a text message, e-mail or other text based message for reply with the code automatically to save the user the cutting and pasting. The payment service software 32 treats the received approval indicator or a rejection in the text based message reply as the purchase decision and continues processing based on the decision.

In the embodiment, the mobile device application 32 displays in step 782 a display showing links to websites indicated in the user profile in which the user can enter data about the purchase. One may be a link such as a Uniform Resource Locator (URL) to a budgeting software website where the user has an account such as Quicken®. In another example, the mobile device application 22 can download the purchase information over a physical wireless (e.g. Bluetooth) or wired connection (Universal Serial Bus) to another computer system such as the user's home computer. The mobile device application 22 can download the purchase information in the format of the program saving the user data text entry time. Another can be a customer comment site such as Yelp®. In another example, the website can be a social networking website such as Facebook® or Twitter® where the user can comment on her purchase. The mobile device application 22 accesses in step 788 the website via a browser if the user input indicates selection of a website in step 784 or ends in step 786 the processing for responding to the service system 32 regarding payment approval. The mobile device software 22 can automatically format the purchase information such as the exemplar data items illustrated in the purchase response data set in a form of a draft entry for a social networking site or a customer comment site for the user to edit.

If the user preferences indicate to go automatically to a particular website after each purchase or a category of purchase, rather than showing a display with links to different websites indicated in the user account profile, the mobile device software 22 can access the particular website directly or via a payment service server 30 of the payment service network 30. If the user preferences permit, the user's account on the third party software (e.g. Facebook, Yelp) can be opened automatically saving the user time in making a comment.

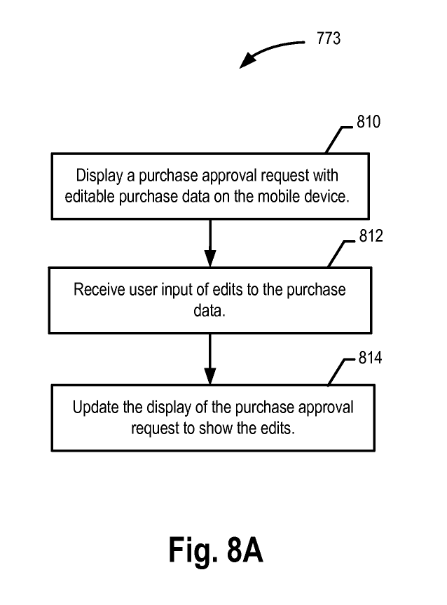

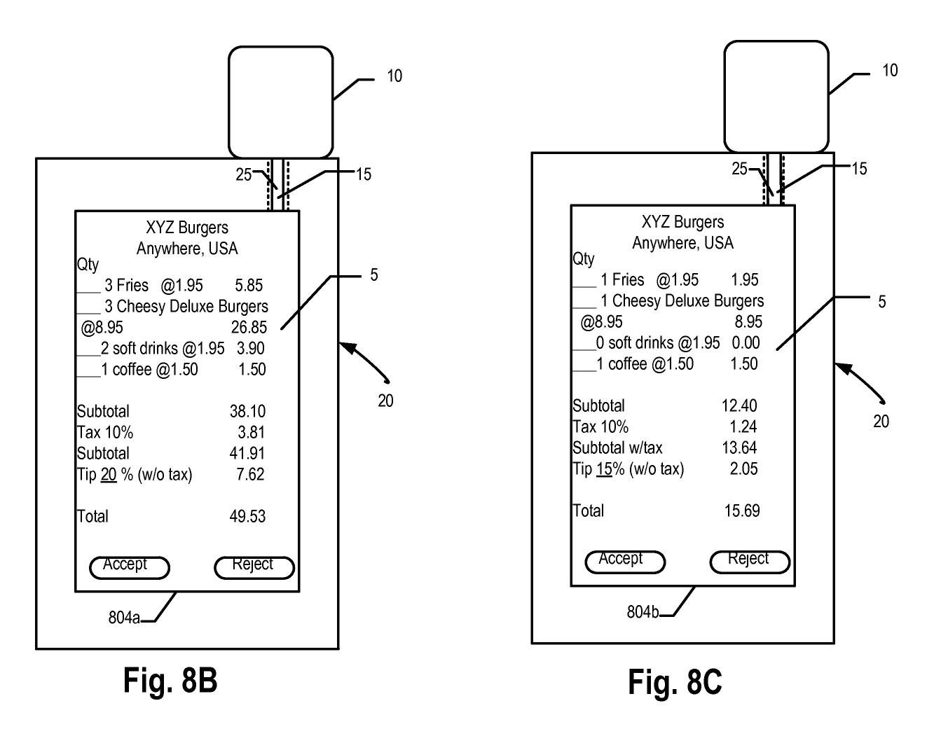

In some purchase situations, a user is responsible for only part of a bill. The restaurant bill with a group of friends is such a situation. Step 773 in FIG. 7E of displaying a purchase approval request including a purchase data set on the mobile device can be modified as shown in the FIGS. 8A-8C to allow editing of the purchase data in the display for a method of paying part of a bill in a mobile device payment system.

FIG. 8A is a flowchart of one embodiment of a method for displaying a purchase approval request as part of a partial bill payment feature in a mobile device payment system. FIG. 8A is discussed in reference to FIGS. 8B and 8C for illustrative purposes only and not to be limiting thereof. The mobile device application 22, for example the purchase confirmation software 590 in FIG. 5F, in step 810 displays a purchase approval request with editable purchase data on the mobile device display 5.

FIG. 8B is an example of such a display 804a. In the example of FIG. 8B, the display of a restaurant bill is generated from a purchase data set (e.g. 794) received from the payment service software 32. There were 3 fries and 3 Cheesy Deluxe Burgers ordered as well as 2 soft drinks and 1 coffee. The display is interactive so the user can edit the purchase data. The display example 804a has a selectable “Qty” field in which a user can enter a quantity of an item for which the user desires to pay. Additionally, a tip percentage field can be modified by the user. In this example, the default percentage is 20.

The mobile device application 22 in step 812 receives user input of edits to the purchase data, and in step 814 updates the display of the purchase approval request to show the edits. FIG. 8C is an example of an updated display 804b showing the user's modifications to the bill to cover the portion of charges he or she incurred. The user is paying for only 1 of the fries, 1 of the burgers and his or her coffee. Furthermore, the user has entered “15” for the tip percentage. He or she can then hit the “Accept” button in this example to complete the approval. Of course, he or she can reject the changes and start over.

The mobile device application 22 continues the processing of FIG. 7E in step 776 of FIG. 7E by updating the purchase description and purchase total in the generation of the purchase response data set 796 to reflect the user's changes. The payment service software 32 receiving the purchase response data set transmitted in step 780 by the mobile device 20 and processes this amount for payment approval in step 762 of FIG. 7D from the payment account manager software 62 and notifies the merchant software 52, which is waiting to receive the payment approval as per step 746 of FIG. 7C, of the updated purchase description, purchase total and approved payment amount.

In another embodiment, such a display which allows a user to select a number of items from a total bill for which he wishes to pay can be displayed on a reader computer display. The user can select the quantity amounts and tip amount using the touchscreen of the reader display 522, finalize the total, and then use his or her accessory in making a payment, for example as discussed in the embodiments describe in the figures above.

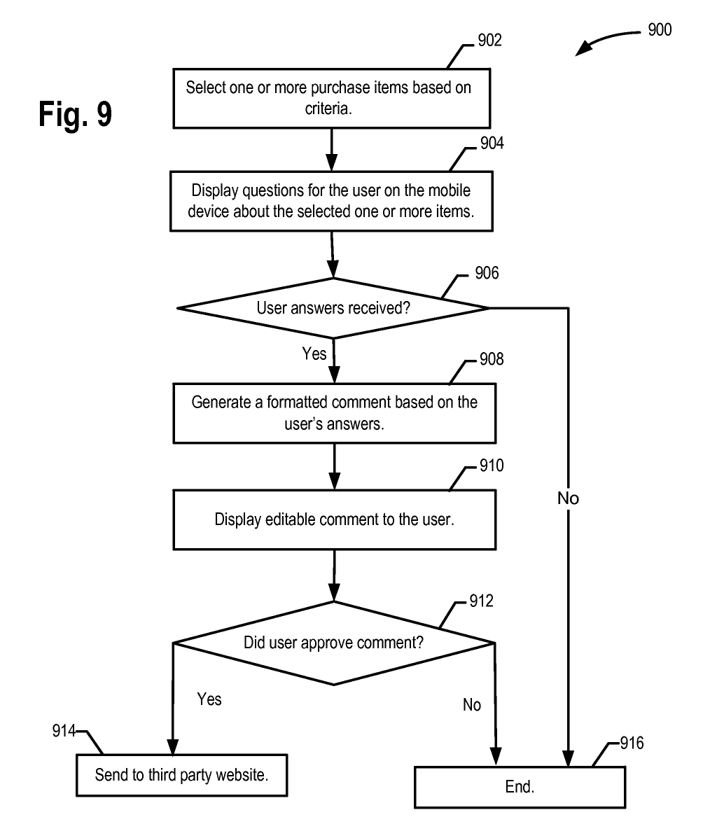

FIG. 9 is an embodiment of a method for automated formatting of user feedback on a purchase transaction. The service software 32 running as a server application with the mobile device application 22 acting as a client or the mobile device software 22 directly or the two in combination may perform the steps of the method 900 illustrated in FIG. 9. For ease of reference, the automated formatting method is discussed with the mobile device application 22 mainly performing the functions. The mobile software 22 selects one or more purchase items based on criteria in step 902.

The criteria may have come from the payment service software 32. An example of criteria is lists of items or services which merchants have requested feedback on from the payment service 30. In another example, the criteria may be based on criteria for a category. An illustrative example is provided in which user preferences indicate the user wishes to provide a review after each restaurant purchase to a restaurant review website. From purchase data (e.g. 794 or 796), the merchant ID is identified. The software 22 accesses the restaurant's menu on its website or a searchable version of categories such as entrees, desserts, drinks, wines, etc. made available via the payment service 32. Using logic for restaurants, entrees may receive a higher priority for rating followed by desserts, wines, alcoholic drinks, etc. Based on the searchable entrees, the software 22 or the payment service software 32 may identify matches in the entrees and the other categories.

In this example, based on matched items, the mobile device application 22 in step 904 displays questions for the user on the mobile device about the selected one or more purchase items. In one example, the question can identify a specific item and ask for a ranking in a numerical range or a range of descriptive words, for example “bad”, “ok”, “good” “very good” and “excellent.” Additionally, questions about general items related to a purchase such as the service and timeliness may be displayed.

The software 22 determines in step 906 if user answers have been received, or received within a time frame. If the time to answer has passed or the user closed the display to end the review process, the processing for the pre-formatted user feedback ends.

Otherwise, the software 22 generates a formatted comment based on the user's answers in step 908, and displays an editable comment to the user in step 910. The formatted comment may be written in a paragraph of standard lines populated with the names of purchase items and comments such as “bad” “ok” “good” “excellent” based on the user responses. It may also lists the items with the ranking next to them.

The user can edit, and the software 22 determines if the user has approved the comment in step 912. If not, the processing may end in step 916. If the user approves the comment, the software 22, perhaps via the payment service software 32, sends the comment to a third party website in step 914.

As previously mentioned, the embodiments of a mobile device payment system disclosed above can also work with an accessory which is internal rather than external to a mobile device. For example, a programmable RFID transmitter can be internal to a mobile device, and transmit the transaction data stored on the mobile device to a reader computer. Mobile devices can be purchased with Radio Frequency Identification (RFID) capability built into a device's subscriber identity module (SIM) card. For a mobile device with an RFID transceiver or transmitter included in the SIM card, if the mobile device is lost or stolen, the RFID transceiver or transmitter can be turned off by the mobile service provider with the rest of the SIM card.

The technology may be embodied in other specific forms without departing from the spirit or essential characteristics thereof. Likewise, the particular naming and division of modules, routines, features, attributes, methodologies and other aspects are not mandatory, and the mechanisms that implement the technology or its features may have different names, divisions and/or formats. Furthermore, as will be apparent to one of ordinary skill in the relevant art, the modules, routines, features, attributes, methodologies and other aspects of the embodiments disclosed can be implemented as software, hardware, firmware or any combination of the three. Of course, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of programming.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of making a payment using a mobile device, comprising:
transmitting, by a mobile device system, a transaction data set including a user account identification for a payment service account to a transceiver of a reader computer at a merchant location within a vicinity of the mobile device system, the reader computer being connected to a merchant computer network system in communication with a computer system of a payment service, the transmitting is associated with a transaction;
receiving, at the mobile device that is associated with the user account identification, a message requesting approval of the transaction from the computer system of the payment service via a communication network accessible by the mobile device; and
sending a response message from the mobile device including a purchase decision for the transaction to the computer system of the payment service via the communication network.

2. The method of claim 1, further comprising:
the mobile device system comprising the mobile device and a mobile device removable accessory;
automatically detecting that the mobile device removable accessory has been removed from the mobile device; and
erasing the transaction data set from the mobile device removable accessory in response to detecting that the mobile device accessory has been removed from the mobile device.

3. The method of claim 1, further comprising:
authenticating that the message requesting approval of the transaction is from the computer system of the payment service based on encryption data which is stored by both the mobile device and the computer system of the payment service.

4. The method of claim 1 further comprising:
responsive to user input including a transaction password, software executing on the mobile device generating and sending a response message including the purchase decision to the computer system of the payment service via the communication network.

5. The method of claim 1 wherein:
the message requesting approval further comprises purchase data including a purchase description including one or more item descriptions and editable quantity fields and a purchase total amount;
the method further comprises receiving one or more user input edits to the quantity fields, determining any change to the purchase total amount due to the user input edits to the quantity fields, and editing the purchase data by software for implementing a partial bill payment feature executing on the mobile device in response to and based on the user input edits and any change to the purchase total amount;
including the edited purchase data in the response message; and
responsive to receiving user input approving the transaction of the edited purchase data, software executing on the mobile device generating an approval indicator as the purchase decision for the purchase total amount including any change to the purchase total amount due to the user input edits to the quantity fields.

6. The method of claim 1 further comprising:
the message requesting approval of the transaction from the computer system of the payment service is a text based message;
responsive to user input approving the transaction, software executing on the mobile device generating an approval indicator as the purchase decision;
responsive to user input rejecting the transaction, software executing on the mobile device generating a rejection as the purchase decision; and
the software executing on mobile device sending a response message from the mobile device system to the computer system of the payment service includes sending a text based message including the purchase decision.

7. The method of claim 1 further comprising:
responsive to the sending a response message from the mobile device including a purchase decision for the transaction, software executing on the mobile device automatically accessing a website identified in user profile data for the payment service account; and
the software executing on the mobile device formatting data about the transaction in a form for use by the website.

8. The method of claim 7, wherein:
the software executing on the mobile device formatting data about the transaction in the form for use by the website further comprises:
displaying a question on a display of the mobile device about an item in the transaction;
generating a formatted comment based on user input including an answer to the question;
displaying the formatted comment on the display of the mobile device; and
responsive to user input indicating approval of the comment, sending the comment to the website.

9. The method of claim 1, wherein:
the message requesting approval further comprises purchase data including a purchase description, a purchase total amount, and a loyalty reward data item.

10. The method of claim 1, wherein:
the message requesting approval further comprises purchase data including a purchase description and a purchase total amount; and
the purchase total amount automatically including a loyalty reward.

11. A removable accessory for a mobile device for use in a mobile device payment system comprising:
an external input interface for physically connecting the removable accessory to the mobile device;
an accessory processor communicatively coupled via the external input interface to the mobile device for receiving data from the mobile device, the data including an account identification;
a memory system accessible by the accessory processor, the memory system stores the data;
a transceiver of the removable accessory communicatively coupled to the accessory processor for receiving instructions from the accessory processor and for communicating the account identification to a reader computer at a merchant location communicatively coupled to a merchant computer network system when the transceiver is in a vicinity of the reader computer; and
a connection detection circuit of the removable accessory communicatively coupled with the accessory processor for automatically detecting the connection state of the removable accessory with respect to the mobile device, the accessory processor erasing the data in response to an indicator from the connection detection circuit that the removable accessory has been disconnected from the mobile device.

12. (canceled)

13. The removable accessory of claim 11 wherein:
the memory system stores software executable by the processor for placing the removable accessory in an inactive mode responsive to the removable accessory having been disconnected from the mobile device.

14. The removable accessory of claim 11 wherein the connection detection circuit includes a capacitance sensor.

15. The removable accessory of claim 11 wherein the connection detection circuit includes a magnetic field sensor.

16. The removable accessory of claim 11, wherein:
the memory system includes software executable by the processor for changing the removable accessory from an inactive mode to an active mode in response to detection of a signal from the transceiver of the merchant computer network system.

17. The removable accessory of claim 11 wherein:
the external input interface provides a wireless connection between the processor and the mobile device.

18. The removable accessory of claim 11 wherein:
the external input interface is an earphone connector for physically connecting the removable accessory to an earphone jack of the mobile device;

19. (canceled)

20. The removable accessory of claim 18, further comprising:
an analog to digital converter for converting data in an analog signal received by the earphone connector from the mobile device to a digital signal including the account identification for the accessory processor.

21. The removable accessory of claim 20, wherein:
the analog to digital converter comprises a demodulator which formats tones of the analog signal to digital data including the account identification; and
the processor stores the digital data in the memory system.

22. The removable accessory of claim 11, further comprising:
the transceiver is a wireless transceiver and receives a wireless signal from the merchant computer network system and communicates the account identification for a purchase transaction to the merchant computer network system in response to receiving the wireless signal from the merchant computer network system.

23. The removable accessory of claim 22, further comprising:
purchase confirmation software stored and executing on the mobile device,
receives a confirmation request from a remote computing system for the purchase transaction, for which the wireless transceiver of the removable accessory communicated the account identification to the reader computer at the merchant location communicatively coupled to the merchant computer network system,
requests the user of the mobile device to approve the purchase transaction, and
sends a response message including a purchase decision for the transaction to the remote computing system.

24. A method of making a payment using a mobile device removable accessory comprising:
responsive to receiving a signal from a transceiver connected to a merchant computer system, the mobile device removable accessory checking its connection state with respect to a mobile device;
responsive to the connection state indicating the removable accessory has not been disconnected from the mobile device since an initialization procedure had been performed, the removable accessory generating a transaction data set comprising a user account identification for a payment service account, an accessory identification, and an encrypted request identification for a transaction, and
the removable accessory transmitting the transaction data set to the transceiver connected to the merchant computer network system; and
responsive to the connection state indicating the removable accessory has been disconnected from the mobile device since the initialization procedure had been performed, transitioning the accessory to an inactive mode.

25. The method of claim 24, further comprising:
the mobile device receiving user input approving the transaction;
the mobile device generating an approval indicator and sending the approval indicator to the removable accessory;
the removable accessory storing the approval indicator for a time limited period; and
the removable accessory transmitting the approval indicator to the transceiver of the merchant computer network within the time limited period.

26. The method of claim 25, further comprising:
the removable accessory deleting the approval indicator after the time limited period expires.

27. The method of claim 24, further comprising:
receiving from the mobile device a payment account identifier which indicates which one of a plurality of payment accounts associated with the user payment service account identification to use for the transaction; and including the payment account identifier in the transaction data set.

28. The method of claim 24, further comprising:
responsive to receiving a signal from a transceiver connected to a merchant computer network system, the mobile device removable accessory transitioning to an active mode from a sleep mode.

29. The method of claim 24, further comprising:
payment service software executing in a payment service computer system receiving over the Internet from the merchant computer network system a merchant data set, the merchant data set including the transaction data set, merchant identification, and purchase data including a purchase total, and a transaction time; and
the payment service software verifying the transaction is valid based on the transaction time and the request identification of the transaction data set.

30. The method of claim 29 wherein the payment service software verifying the transaction is valid based on the transaction time and the request identification of the transaction data set further comprises:
generating, using accessory encryption data stored in the payment computer system network for the removable accessory identified in the accessory identification,
a first encrypted version of the transaction time in the merchant data set,
a second encrypted version of a time a predetermined time period before the transaction time, and
a third encrypted version of a time a predetermined time period after the transaction time; and
determining whether there is a match with the request identification and any of the encrypted versions.

31. The method of claim 29, wherein the payment service software verifying the transaction is valid based on the transaction time and the request identification of the transaction data set further comprises:
the request identification including a current time value representing the time the removable accessory transmitted the transaction data set encrypted with accessory encryption data stored on the removable accessory; and
the payment service software verifying the transaction is valid based on the transaction time and the request identification of the transaction data set by decrypting the request identification to obtain the current time value using accessory encryption data stored in the payment computer system network for the removable accessory identified in the accessory identification, and determining whether there is a match with the current time value and any of the following:
the transaction time in the merchant data set,
a time of a predetermined time period before the transaction time, and
a time of a predetermined time period after the transaction time.

32. The method of claim 29, further comprising:
the payment service software executing in the payment service computer network checking whether there is a pre-authorization criteria associated with the user payment service account identification; and
responsive to the pre-authorization criteria being satisfied, the payment service software next processing payment by communicating with software executing on a computer system of a payment account manager which manages a payment account for the user, the payment account being associated with the payment service account identification of the transaction data set rather than sending a message requesting approval of the transaction to the mobile device.
